(19) United States
(12) Patent Application Publication
(10) Pub. No.: US 2010/0177608 A1
(43) Pub. Date: Jul. 15, 2010

(54) OPTICAL DISC AND METHOD FOR CONTROLLING THE SAME

(76) Inventors: Hideo Morishita, Osaka (JP); Takayuki Deai, Osaka (JP); Masanori Nagata, Kyoto (JP); Masaya Kuwahara, Hyogo (JP); Hiroyuki Yabuno, Osaka (JP)

Correspondence Address: MCDERMOTT WILL & EMERY LLP, 600 13TH STREET, NW, WASHINGTON, DC, 20005-3096, US

(21) Appl. No.: 12/438,270

(22) PCT Filed: Aug. 20, 2007
(86) PCT No.: PCT/JP2007/066117

§ 371 Date: Feb. 20, 2009

(30) Foreign Application Priority Data
Aug. 21, 2006 (JP) 2006 224066

(51) Int. Cl. G11B 20/00; G11B 7/00

(52) U.S. Cl. 369/47.15; 369/53.2; G9B/7; G9B/20

(57) ABSTRACT

In an optical disc having a multilayer structure in which recording layers are bonded to each other, the number of times additional writing can be performed is increased. A method for controlling an optical disc device according to the present invention comprises steps of calculating a displacement amount generated when the recording layers are bonded to each other; and identifying the size of a recordable area in a non-usable area predetermined on the recording layer based on the displacement amount.

### FIELD OF THE INVENTION

The present invention relates to an optical disc device capable of recording and reproducing data of an optical disc comprising a large number of recording layers which are bonded to one another, and a method for controlling the optical disc device.

### BACKGROUND OF THE INVENTION

In order to manufacture an optical disc comprising a large number of recording layers, the respective recording layers are bonded to one another. In an optical disc having a bilayer structure, when a first information recording layer and a second information recording layer are bonded to each other, the information recording layers may be bonded at a position different to a predetermined bonding position. In an optical disc exemplified by a DVD-R Dual Layer medium, a position displacement may occur between the first information recording layer and the second information recording layer. Therefore, Gap (The area located in the Disc Testing Area (DTA) to prevent the influence of recordings for OPC on the other layer. Gap shall not be used for OPC procedure.), which is a non-usable area where recording is not allowed, is defined on the second information recording layer in order to solve the problem. When data is recorded on the second information recording layer, the recording starts at a position on an inner-peripheral side than a recording position on the first layer in view of the Gap. A maximum size of the Gap (non-usable area) is inner 257 ECC blocks (4,112 sectors) and outer 676 ECC blocks (10,816 sectors).
PATENT DOCUMENT: H05-54396 of the Japanese Patent Applications Laid-Open

### Problem to be Solved by the Invention

When data is recorded in the user data area of a optical disc, a test recording is conventionally implemented to a test recording area before data is actually recorded thereon to perform the adjustment of laser power and the like, the object of which is to reliably perform the recording in the user data area. An optical disc comprising a large number of recording layers, however, comprises a non-usable area in the test recording area. Therefore, the area usable for the test recording is lessened in comparison to an optical disc comprising a single layer.

In an optical disc where two layers can be used for the recording operation such as a DVD-R Dual Layer medium, in particular, the recordable user data area is larger than that of a single-layer disc. Therefore, the possibility of additional writing is higher comparing with a the monolayer disc.

As soon as the test recording area in the optical disc has run out, however, the test recording is no longer possible even in the case of an optical disc in which where there is still a blank space in the user data area. As a result, recording in the user data area becomes impossible, and therefore the number of times additional writing can be implemented in the bilayer optical disc is lessened compared with the monolayer disc.

The present invention was made in order to deal with the disadvantage mentioned above, and a main object thereof is to increase the number of times additional writing can be implemented in an optical disc comprising the multiple recording layers bonded to one another.

### Means for Solving the Problem

A method for controlling an optical disc device according to the present invention is a method for controlling an optical disc device for recording and reproducing data of an optical disc having a multilayer structure in which recording layers are bonded to each other, comprising steps of:

calculating a displacement amount generated when the recording layers are bonded to each other; and

identifying a size of a recordable area in a non-usable area predetermined on the recording layer based on the displacement amount.

In the method for controlling the optical disc device, addresses at the same radius position have a predetermined correlation between the recording layers of the optical disc having the multilayered structure in the case where the optical disc has such a normal structure that the displacement due to the bonding process is not generated in the layers. In the case where the recording layers are displaced from each other in a manufacturing process, however, the addresses at the same radius position between the respective recording layers no longer have the predetermined correlation. Therefore, the addresses of the respective recording layers are compared so that an amount of the displacement is calculated, and the recordable area in the predetermined non-usable area is specified based on the calculated displacement amount. The information of the specified recordable area is preferably memorized. An example of the non-usable area is the GAP area in a DVD-R Dual Layer medium.

In the conventional technology, a recordable area is searched in the area of the disc which is deemed non-usable to obtain information on the recordable area. When additional writing is executed to the optical disc comprising the multiple recording layers from which such information was obtained, the recordable area is determined based on the information of the recordable area and used for additional writing. As a result, the number of times additional writing can be performed is increased in the optical disc.

The method for controlling the optical disc device according the present invention preferably further comprises steps of:

perform a search to check whether or not there is a residual test-recordable area in a test recording area provided in the optical disc when a test recording is implemented to the optical disc;

performing a search to check whether or not there is a residual recordable area in the non-usable area when it is determined that the residual test-recordable area is not present in the test recording area; and

implementing the test recording in the residual recordable area in the non-usable area when it is determined that the residual recordable area is present in the non-usable area.

According to the method for controlling the optical disc device provided by the present invention, the recordable area is set in the area of the disc which was conventionally regarded as the non-usable area, and the set recordable area is used for the test recording. Therefore, the recordable area is increased in comparison to the case where the conventional recording area was used, and consequently the number of times additional writing can be performed can be increased. Further, the recordable area is used for the test recordable area only when the conventional test recording area ran out. Therefore, the interchangeability of the recording and reproducing operations with a conventional optical disc device can be maintained.

The method for controlling the optical disc device according the present invention preferably further comprises steps of:

checking whether or not there is specific control information generated depending on the combination of the optical disc and the optical disc device;

checking whether or not there is a residual recording area in the non-usable area when it is determined that the specific control information is present; and

recording the specific control information in the residual recording area in the non-usable area when it is determined that the residual recordable area is present in the non-usable area.

According to the method for controlling the optical disc device provided by the present invention, a recording area which is conventionally regarded as the non-usable area can be effectively used as the area for recording the specific control information generated depending on the combination of the optical disc and the optical disc device. As a result, a recording quality can be further improved.

### EFFECT OF THE INVENTION

According to the present invention, in the multilayered optical disc comprising the recording layers bonded to one another, wherein the test recording is implemented to the recordable area in the non-usable area, the number of times additional writing can be performed can be increased.

### BRIEF DESCRIPTION OF THE DRAWINGS

FIG. 1 is a block diagram illustrating a constitution of an optical disc device to which a control method according to a preferred embodiment of the present invention is applied.

FIG. 2 is a schematic view of a structure of a DVD-R Dual Layer optical disc.

FIG. 3 is a flow chart illustrating a GAP area search operation by the optical disc device according to the present preferred embodiment.

FIG. 4 is a flow chart illustrating a test recording operation by the optical disc device according to the present preferred embodiment.

FIG. 5A is an illustration of tracks of recording layers of the optical disc.

FIG. 5B is an illustration of the tracks of the recording layers of the optical disc in further detail.

FIG. 6A is a first graph chart illustrating a relationship between a distance R and a rotation angle θ.

FIG. 6B is a second graph chart illustrating the relationship between the distance R and the rotation angle θ.

FIG. 7 is a block diagram illustrating a detailed structure of an optical disc device to which a control method according to a preferred embodiment of the present invention is applied.

FIG. 8 is a flow chart illustrating a test recording operation by the optical disc device according to the preferred embodiment.

FIG. 9 is a block diagram illustrating a detailed structure of an optical disc device to which a control method according to a preferred embodiment of the present invention is applied.

FIG. 10 is a flow chart illustrating a test recording operation by the optical disc device according to the present preferred embodiment.

FIG. 11A is an illustration of tracks of recording layers of the optical disc.

FIG. 11B is an illustration of the tracks of the recording layers of the optical disc in further detail.

FIG. 12 is an illustration of the variation of a lens position at the time of tracking control.

FIG. 13 is a block diagram illustrating a detailed structure of an optical disc device to which a control method according to a preferred embodiment of the present invention is applied.

FIG. 14 is an illustration of an output of a tracking controller and an output of a clock generator.

FIG. 15 is a flow chart illustrating a test recording operation by the optical disc device according to the preferred embodiment.

FIG. 16 is a flow chart illustrating the operation of the test recording operation by the optical disc device according to the present preferred embodiment.

FIG. 17 is an illustration of a relationship between a displacement amount and a recording area used in one test recording.

FIG. 18 is a block diagram illustrating a detailed structure of an optical disc device to which a control method according to a preferred embodiment of the present invention is applied.

FIG. 19 is a block diagram illustrating a detailed structure of an optical disc device to which a control method according to a preferred embodiment of the present invention is applied.

FIG. 20 is a flow chart illustrating a test recording operation by the optical disc device according to the preferred embodiment.

FIG. 21 is a block diagram illustrating a detailed structure of an optical disc device to which a control method according to a preferred embodiment of the present invention is applied.

FIG. 22 is an illustration of a relationship among a rotation position of an optical disc, a displacement amount, an output te, a binarized signal of the output te, and an output tef.

FIG. 23 is a flow chart illustrating a disc information recording operation by the optical disc according to the preferred embodiment.

### DESCRIPTION OF REFERENCE SYMBOLS

E optical disc device
L9 first information recording layer
L1 second information recording layer
1 optical disc
2 spindle motor
3 optical pickup
4 thread
5 disc rotation controller
6 signal processor LSI
7 DRAM buffer
8 CPU
9 transmitter
10 receiver
11 test result storage memory
12 recording/reproducing device
111 disc rotation controller
112 focus error detector
113 tracking error detector
114 address detector
115 focus controller
116 tracking controller
117 displacement amount detector
118 optical output detector
119 optical output controller
120 clock generator
121 switch
122 tracking error cycle detector

### PREFERRED EMBODIMENTS FOR CARRYING OUT THE INVENTION

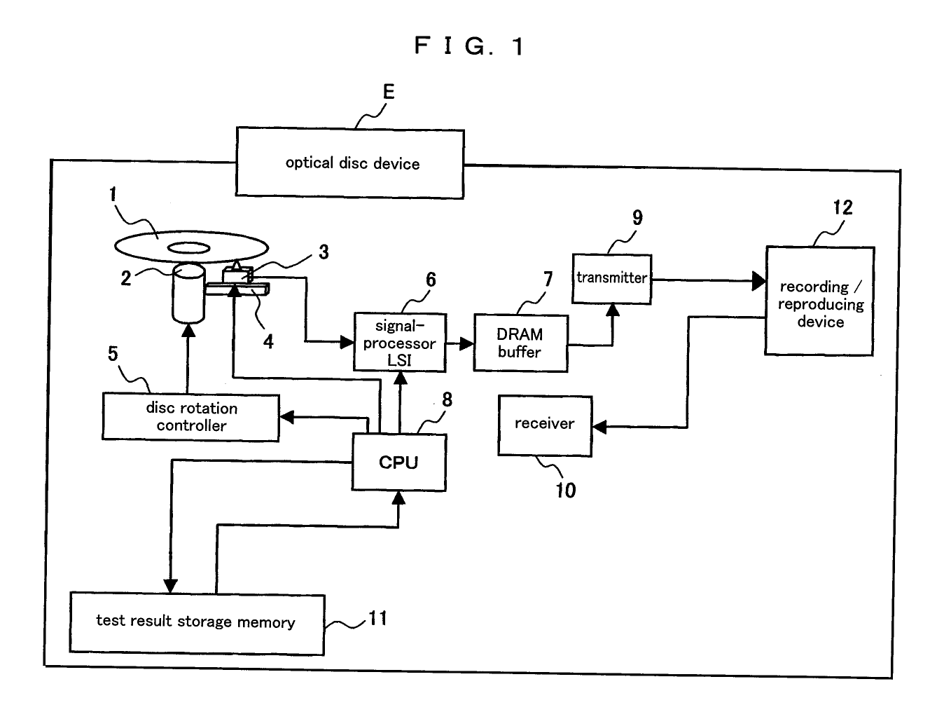

Hereinafter, preferred embodiments of an optical disc control method according to the present invention are described in detail referring to the drawings. FIG. 1 is a block diagram illustrating a constitution of an optical disc device to which a control method according to a preferred embodiment of the present invention is applied.

In FIG. 1, 1 denotes an optical disc having a multilayered structure wherein recording layers are bonded to each other. In this description, the optical disc is a DVD-R Dual Layer medium comprising first and second information recording layers bonded to each other, wherein a write-once function having at least two information recording layers is provided. E denotes an optical disc device, 11 denotes a test result storage memory, and 12 denotes a recording/reproducing device.

The optical disc device E comprises a spindle motor 2 which rotates the optical disc 1, an optical pickup (optical head) 3 which records and reproduces data with respect to the optical disc 1, a thread 4 which guides the optical pickup 3 along a radial direction of the optical disc 1, a disc rotation controller 5 which controls the spindle motor 2, a signal processor LSI 6 which variously processes an electrical signal corresponding to an optical signal read from the optical disc 1 by the optical pickup 3 and outputs the processed signal as digital data, a DRAM buffer 7 in which the digital data obtained by the signal processing by the signal processor LSI 6 is temporarily stored, a CPU 8 which controls the structural elements of the optical disc device E (optical pickup 3, thread 4, disc rotation controller 5, signal processor LSI 6, test result storage memory 11, and the like), a transmitter 9 which transmits the digital data from the DRAM buffer 7 to an external recording/reproducing device 12, and a receiver 10 which receives the data and signal transmitted from the recording/reproducing device 12.

The optical pickup 3 is controlled by the CPU 8 to move on the thread 4 to thereby write data at a predetermined position on the optical disc 1 and read data at the predetermined position The CPU 8 comprises a function to adjust laser power and a learning function to correct the laser power to an optimal level based on the control by the CPU 8.

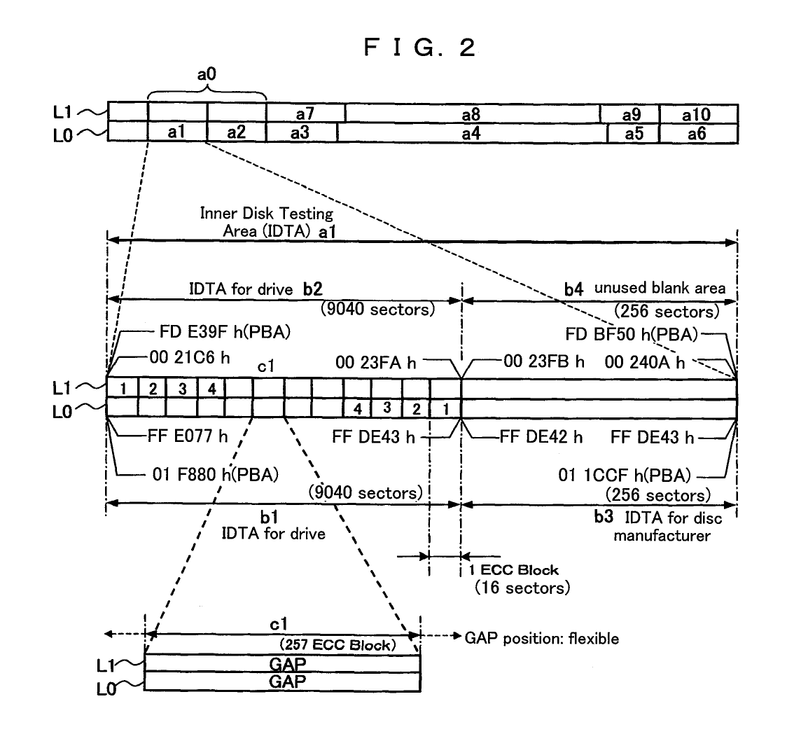

FIG. 2 schematically illustrates a structural example of the DVD-R Dual Layer optical disc 1.

In FIG. 2, a1 denotes an inner disc test recording area (IDTAZ: Inner Disc Testing Area), a2 denotes a recording management area (RMA), a0 denotes an information recording area comprising the two areas a1 and a2, a3 denotes a read-in area, a7 denotes a read-out area, a4 and a8 denote a data recording area, a5 and a9 denote a fixed intermediate area, and a6 and a10 denote an outer disc test recording area (ODTAZ: Outer Disc Testing Area).

The inner disc test recording area a1 comprises drive-purpose test recording areas (IDTA for drive) b1 and b2, a disc-manufacturing-purpose test recording area (IDTA for disc manufacturer) b3, and an unused blank area b4. The capacity of the drive-purpose test recording areas (IDTA for drive) b1 and b2 is 9,040 sectors, and the GAP cl is included in the drive-purpose test recording areas (IDTA for drive) b1 and b2. The capacity of the GAP is 257 ECC blocks at maximum on the inner side. Each of the ECC blocks has the capacity of 16 sectors.

An operation of the optical disc E according to the present preferred embodiment thus constituted is described below. The operation is described referring to a case where the receiver 10 was requested to record data by the recording/reproducing device 12 in the optical disc device E. The optical disc device E determines whether or not a test recording was already implemented to the optical disc 1 loaded therein. When it is determined that the test recording has not been implemented yet, the optical disc device E implements the test recording operation. In the case where the test recording was successful, the optical disc device E records data on the optical disc 1 as requested by the recording/reproducing device 12.

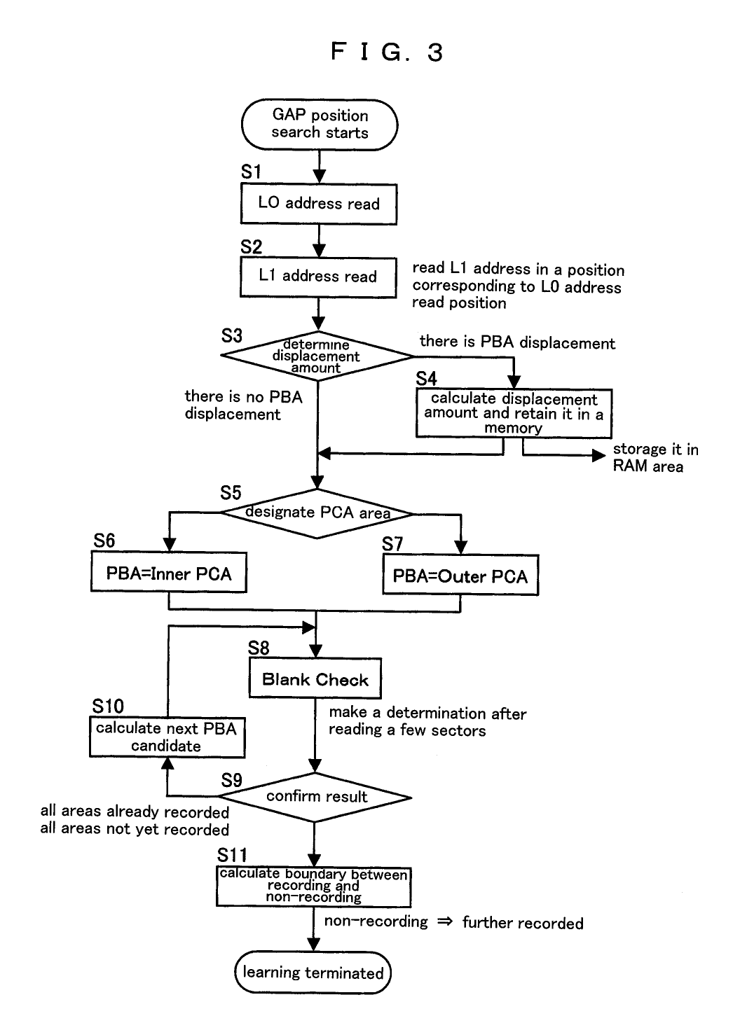

FIG. 3 is a flow chart illustrating an example of a GAP area search operation by the optical disc device E. When the search for the GAP position starts, address-read processing is executed to a first information recording layer L0 in Step S1. The address used in this description denotes a physical address on the optical disc 1. Then, in Step S2, the address-read processing jumps to a second information layer L1 immediately above the address position obtained on the first information recording layer L0, and the address-read processing is executed thereto. The address positions of the respective recording layers facing one another are ideally the same position in the radial direction of the optical disc 1.

In Step S3, a displacement, which is generated when the first information recording layer L0 and the second information recording layer L1 are bonded to each other so that the optical disc 1 is produced, is determined from the correlation between the two addresses read from the first information recording layer L0 and the second information recording layer L1 respectively. The displacement is determined, for example, by judging whether or not the addresses of the first information recording layer L0 and the second information recording layer L1 respectively fall within certain values corresponding to each other. More specifically, it is determined that a displacement does not exist in the case where the address of the second information recording layer L1 shows a substantially inverse value of the address of the first information recording layer L0, while it is determined that a displacement exists if such is not the case. The operation advances to Step S4 in the case where a displacement generated when the layers are bonded to each other to manufacture the optical disc is detected between the addresses of the first information recording layer L0 and the second information recording layer L1, while the operation advances to Step S5 if such is not the case.

In Step S4, an amount of the displacement generated when the layers are bonded to each other to manufacture the optical disc is calculated, and the displacement amount is stored in the test result storage memory 11 as a maximum value of the GAP area of the optical disc. When the calculation of the displacement amount is completed in Step S4, the operation according to the flow chart is terminated.

The test result storage memory 11 does not need to be an exclusive memory, but any storage device allocated to a space accessible by the CPU 8 suffices. A part of an arbitrary memory accessible by the CPU 8 or a storage device other than a memory such as a register may constitute the test result storage memory 11.

Referring to the determination of the displacement generated in the bonding process and the calculation of a displacement amount d, the displacement amount d may be simply calculated without the determination of the displacement generated in the bonding process. Then, the displacement amount thereby obtained may be stored in the test result storage memory 11 as the maximum value of the GAP area of the optical disc.

Referring to the determination of the displacement generated in the bonding process and the calculation of a displacement amount d, the displacement amount d may be calculated and then determined if it is larger than a predetermined amount, which corresponds to the determination of the displacement amount d. In the case where it is learnt from the result that the displacement amount d is larger than the predetermined amount, the displacement amount d is stored in the test result storage memory 11 as the maximum value of the GAP area of the optical disc. The detailed steps of the calculation of the displacement amount d will be described later together with methods other than described earlier.

After the steps so far are completed, the displacement amount d is read from the test result storage memory 11 and recorded in a RAM area of the optical disc 1 as disc information. When the displacement amount d (which is stored in the test result storage memory 11) is recorded on the optical disc 1, the data of the displacement amount d is not necessarily recorded in the RAM area mentioned earlier but may be recorded in any area of the optical disc 1. As far as the optical disc device E recognizes where the displacement amount d is recorded, the data may be stored in any area. In the case where the displacement amount d can be measured every time when the optical disc is newly inserted, it is not always necessary to record the displacement amount d on the optical disc 1.

In Step S5, a test recording address is checked for a conventional test recording process. The conventional test recording process is similar to that of the prior art and has no direct bearing on the present invention, but, briefly described below.

In Step S5, the designation of a test recording address PCA (Power Calibration Area) is determined. In the case where it is judged that the inner PCA is designated, a physical block address PBA (Physical Block Address) used for the next additional writing is set in the inner PCA (Step S6). In the case where it is judged that the outer PCA is designated, the PBA is set in the outer PCA (Step S7).

Next, a blank area is checked in Step S8, the PBA for the next additional writing is calculated in Steps S9 and S10, and a boundary between recording and non-recording is calculated in Step S11.

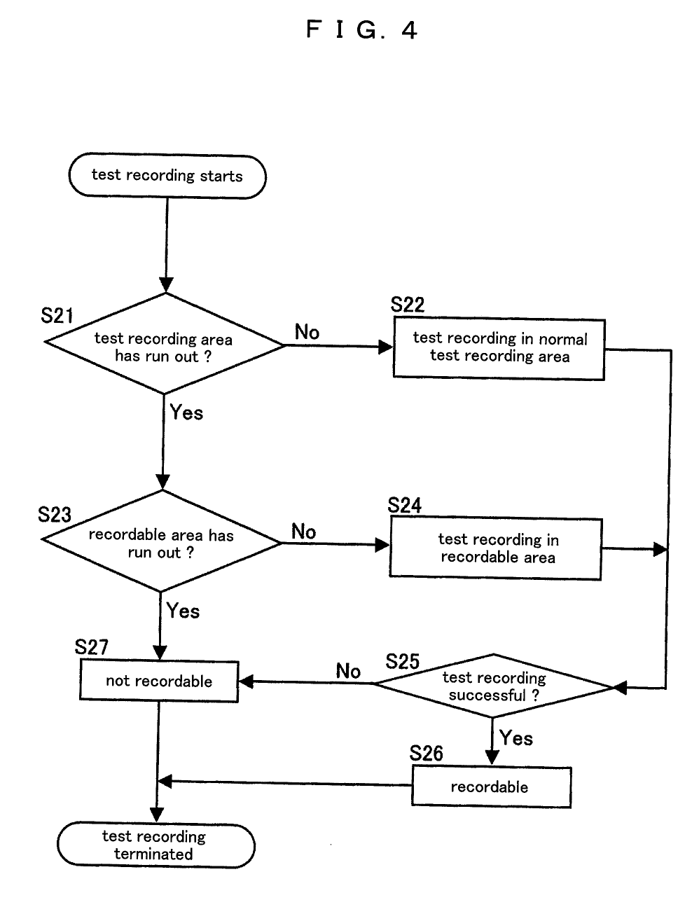

When the learning of the test recording area is thus completed, the operation advances to processing steps illustrated in a flow chart of FIG. 4. FIG. 4 is a flow chart of a test recording operation by the optical disc device E.

In Step S21, it is determined whether or not the test recording area on the optical disc 1 already has run out. In other words, a recordable area is searched, and if the presence of the recordable area is detected, the test recording is implemented there in Step S22. After the implementation of the test recording in the conventional test recording area in Step S22, it is determined in Step S25 whether or not the test recording was successful. In the case where it is determined in Step S25 that the test recording was successful, the optical disc 1 is judged to be recordable. Then, the recording, which was requested to the optical disc device E by the recording/reproducing device 12, is implemented in Step S26.

As additional writing is thus repeatedly implemented, the available recording area finally runs out. It is determined then in Step S21 that the recordable area will run out, and then, the operation advances to Step S23. It is determined in Step S23 whether or not the recordable area, which was calculated in the determination of the displacement amount (see Step S4 illustrated in FIG. 3), has run out in the GAP area deemed to be non-usable, more specifically, a recordable area is actually searched in the GAP area in this step. Still more specifically, in the search of the recordable area, the maximum value information data of the GAP area stored in the RAM area of the optical disc 1 is read, the residual recordable area included in the range of the read maximum values of the GAP area is regarded as the test recordable area, and the presence or absence of the recordable area is detected and its size is measured. In the case where it is determined in Step 23 that the recordable area exists, the operation advances to Step S24, wherein the test recording is implemented to the recordable area in the GAP area.

After the Step S24 (test recording in the recordable area in the GAP area), the operation advances to Step S25, wherein it is determined whether or not the test recording was successful. In the case where the success is determined in Step S25, recording on the optical disc 1 is judged possible (Step 26), and the recording operation starts thereon.

In the case where it is determined in Step S25 that the test recording failed, or it is determined in Step S23 that there is no recordable area in the GAP area, it is determined that the recording operation is not possible (Step S27). Then, the data recording requested by the recording/reproducing device 12 is not implemented to the optical disc device E, and the operation is terminated.

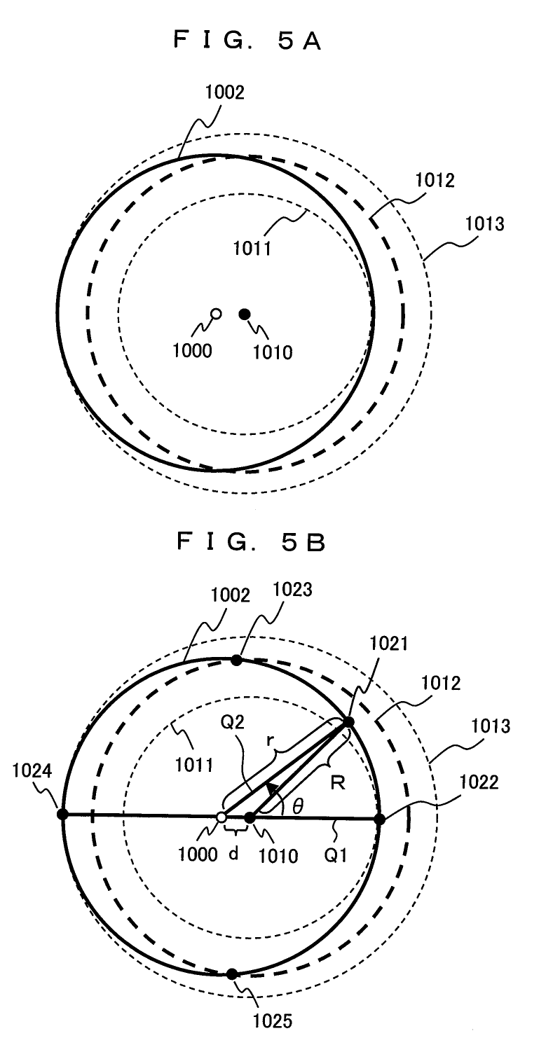

Next, the detailed steps of the “calculation of the displacement amount d” are described below referring to FIGS. 5A, 5B, 6A, 6B, 7A, 7B, and 8-22.

### First Example of the Detailed Steps

Below is described a first example of the detailed steps for the calculation of the displacement amount d. FIG. 5A is an illustration of tracks of the L0 layer and the L1 layer on the optical disc 1. 1000 denotes a center point of the L0 layer, and respective tracks of the L0 layer are concentric circles centered around the center point 1000. The respective tracks of the optical disc 1 are actually formed in a spiral shape; however, each track can be regarded as a circle for convenience since the optical disc 1 comprises a large number of tracks. A track 1002 is a track of the L0 layer and has a circular shape centered around the center point 1000. Similarly, 1010 is a center point of the L1 layer, and tracks 1011, 1012 and 1013 are tracks of the L1 layer, which are concentric circles centered around the center point 1010. The radius of the track 1012 of the L1 layer and the radius of the track 1002 of the L0 layer are substantially equal to each other. The track 1011 of the L1 layer comes in contact with the track 1002 of the L0 layer on the right side of the center points 1000 and 1010 in the drawing. The track 1013 of the L1 layer comes in contact with the track 1002 of the L0 layer on the left side of the center points 1000 and 1010 in the drawing.

Below is specifically described how addresses (physical addresses) are obtained when an inter-layer jump from the L0 layer to the L1 layer and from the L1 layer to the L0 layer is carried out, referring to FIGS. 5B, 6A, 6B, 7A and 7B.

FIG. 5B is a drawing where further descriptions are added to FIG. 5A. In FIG. 5B, r denotes the radius of the track 1002. A point 1021 denotes a point on the track 1002, and a distance between the center point 1000 of the track 1002 and the point 1021 is r. R denotes a distance between the center point 1010 which is the center of a track not concentric with the track 1002 and the point 1021 on the track 1002. d denotes a distance between the center point 1000 and the center point 1010; a track with the center point 1000 and a track with the center point 1010 being eccentric to each other. The distance d corresponds to the displacement amount generated when the two layers are bonded to each other (hereinafter, referred to as displacement amount). θ denotes an angle formed by a line segment Q1 which connects the center point 1000 and the center point 1010 to each other and a line segment Q2 which connects the center point 1000 and the point 1021 to each other. 1022-1025 denote points on the track 1002 of the L0 layer as in the case with the point 1021. 1023 and 1025 each denote an intersecting point between the track 1002 and the track 1012.

In the description given below, the point 1021 denotes a current light spot (point at which laser light is irradiated by the optical pickup 3), and it is assumed that the point 1021 moves from the point 1022 anticlockwise, makes a round of the track via the points 1023-1025, and returns to the point 1022 (a point actually displaced by one track). The angle θ denotes a rotation angle of the light spot, and it can be assumed that the rotation angle θ changes from 0[rad] to 2π[rad]. Practically, it is not the optical pickup 3 that moves on the track but it is the light spot that moves on the track since the optical disc 1 is rotated. The disc 1 is continuously rotated. The following formula (1) is established between the distance R and the rotation angle θ based on a triangular shape formed by the center points 1000, 1010 and 1021.

R=SQRT(r²+d²−2r·d·cos(θ)) (1)

According to the formula (1), the following is obtained.

R=r−d(8=0[rad])

R=r+d(8=π[rad])

R=SQRT(r²+d²)

:θ=π/2[rad], or 8=3π/2[rad]

In the foregoing formula, SQRT(x) is a function which provides a square root of x, and cos(θ) is a cosine function which provides a cosine to the rotation angle θ.

Below is considered a state where the light spot jumps from the L0 layer to the L1 layer at an arbitrary time point in the case where the light spot moves on the track 1022 of the L0 layer (a time point when the light spot is shown at the point 1021). The track of the L1 layer to which the spot light jumps has a circular shape centered around the center point 1010, and a radius thereof is equal to the distance R between the point 1021 and the center point 1010. In the case where the distance R is constant irrespective of the rotation angle θ, the light spot, when it jumps from the L0 layer to the L1 layer, arrives at the track previously anticipated. However, the distance R is actually the function of the rotation angle as described earlier. Therefore, the position of the track at which the spot light arrives in the L1 layer varies depending on the rotation angle θ (in other words, position of the point 1021 on the L0 layer).

The followings can be learnt therefrom.

The L1 layer after the jump is located on an inner-peripheral side of the L0 layer before the jump in a state where the point 1021 is at such a position that the distance R is smaller than the distance r, in other words, in a state where the point 1021 is located before the point 1023 after passing through the points 1025 and 1022.

The L1 layer after the jump is located on an outer-peripheral side of the L0 layer before the jump in a state where the point 1021 is at such a position that the distance R is larger than the distance r, in other words, in a state where the point 1021 is located before the point 1025 after passing through the points 1023 and 1024.

The track 1011 of the L1 layer in contact with the point 1022 is an innermost-peripheral track when the inter-layer jump occurs on the track 1011.

The track 1013 of the L1 layer in contact with the point 1024 is an outermost-peripheral track when the inter-layer jump occurs on the track 1013.

In the case where the inter-layer jump occurs at the point 1023 or 1025, the light spot arrives at the track 1012 of the L1 layer in the same radius position as that of the track 1002 of the L0 layer before the jump.

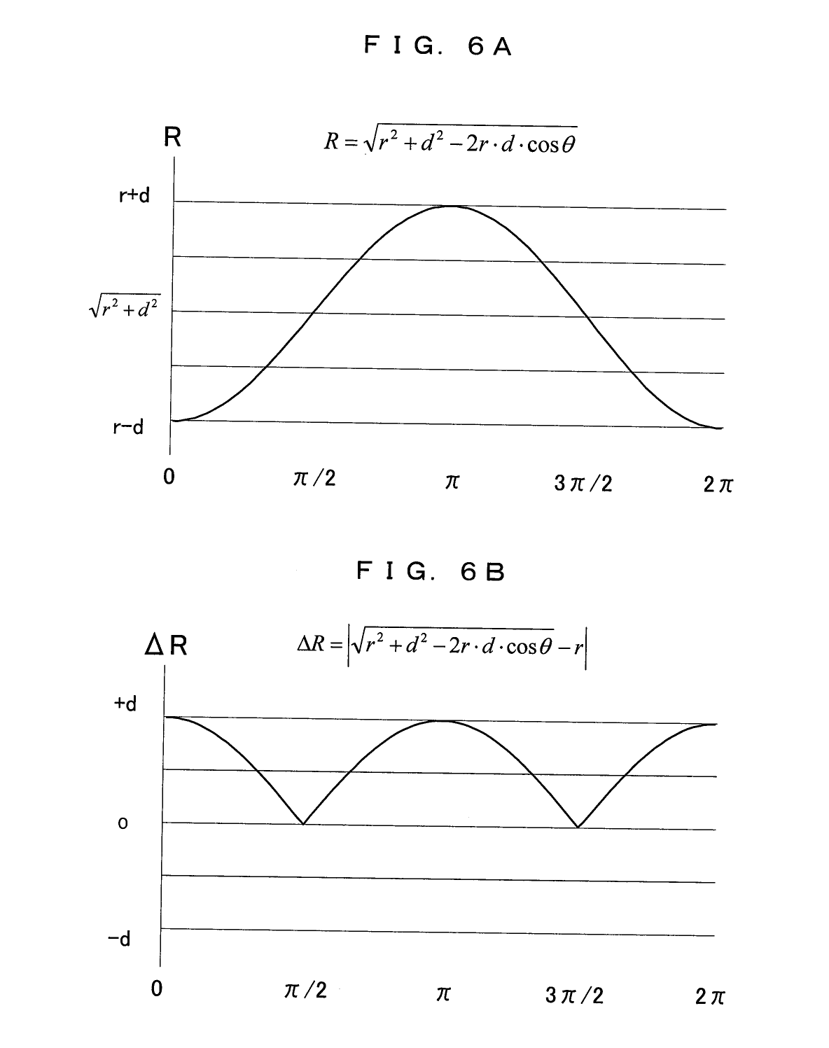

FIG. 6A is a graph illustrating a relational expression between the distance R and the rotation angle θ. The drawing illustrates how the distance R changes as the point 1021 makes a round of the track 1002. A vertical axis shown in the drawing denotes the distance R, while a horizontal axis shows the rotation angle θ. An attention is focused on a rate of change over time dθ/dt (value obtained when θ is differentiated by time) in the rotation angle θ when the point 1021 makes a round of the track 1002 with the center point 1000 as the rotation center. In view of a range of time necessary when the optical disc 1 is rotated through 360 degrees once, the rate of change over time dθ/dt shows a substantially constant value. Therefore, the shape of the graph shown in the drawing does not change even if the horizontal axis θ in FIG. 6A is replaced with the time t. In contrast, the actual rotation center of the optical disc 1 randomly changes every time the optical disc 1 is loaded in the optical disc device E and thereby chucked. Therefore, the rate of change over time de/dt is slightly variable in view of the range of time necessary when the optical disc 1 is rotated through 360 degrees once. However, the optical disc device E is conventionally designed such that an error generated in the chucking stays within a predetermine range, and the rotation center of the optical disc 1 stays in an area around the center point 1000 and the center point 1010. Therefore, it can be said that the variation of the rotation center is such a small that can be ignored.

It can be learnt from FIG. 6A that the distance R after the inter-layer jump from the L0 layer to the L1 layer changes from a minimum value (r−d)=Rmin to a maximum value (r+d)=Rmax depending on the destination point of the inter-layer jump. Accordingly, when the distance R is measured at each of the inter-layer jumps while the interlayer jumps from the respective track positions on the L0 layer to the L1 layer are being performed, the minimum value Rmin and the maximum value Rmax of the distance R can be estimated. Based on the minimum value Rmin and the maximum value Rmax of the distance R, the displacement amount d generated when the L0 layer and the L1 layer are bonded to each other can be calculated by the following formula (2).

d=(Rmax−Rmin)/2 (2)

Further, when the track radius r of the L0 layer before the inter-layer jump is used, the displacement amount d can be calculated by the following formula 3) or 4).

d=Rmax−r (3)

d=r−Rmin (4)

In the description given earlier, R=SQRT(r²+d²) is obtained when θ=n/2[rad] or θ=3π/2[rad] in the formula (1). The displacement amount d at the time is significantly small in comparison to the distance r (d [symbol] r). Therefore, the distance R and the distance r can be expressed as R≈r. Then, the observation of a variation ΔR from the distance R (track radius of L1 layer after the inter-layer jump) to the distance r (track radius before the inter-layer jump) is given below. It is assumed that the variation ΔR denotes an absolute value. A relationship between the variation ΔR and the rotation angle θ is expressed by the following formula (5).

ΔR=ABS(SQRT(r²+d²−2r·d·cos(θ))−r) (5)

However, ABS (x) is a function which provides an absolute value of x. FIG. 6B is a graph illustrating the formula. Since the maximum value of the variation ΔR is d, the variation ΔR may be repeatedly calculated so that a maximum value thereby obtained, ΔRmax, is set as the displacement amount d. This calculation of the displacement amount d is consequently the same as the calculation of the displacement amount d in the following formula (6).

d=Rmax−r (6)

As a possible calculation method of the displacement amount d other than the foregoing manner, the variation ΔR is repeatedly calculated so that an average value ΔRave of the calculated values is obtained, and then, the maximum value ΔRmax (that is the displacement amount d) may be obtained from the calculated average value ΔRave. More specifically, the average value ΔRave in an interval of the formula 5) illustrated in FIG. 6B (θ=0˜2π) can be expressed as ΔRave≈(2d/π); therefore, the displacement amount can be calculated by the following formula (7).

d=ΔRmax≈ΔRave×(π/2) (7)

π stays within the range (3.1<π<3.2). Therefore, the displacement amount d can be estimated when the average value ΔRave is multiplied by approximately 1.55-1.6 times. The range of π which is set to approximately 1.55-1.6 times in the above description, however, is not necessarily limited to such a range. In place of obtaining the index of the variation ΔR, which is the absolute value, the variation ΔR may be doubled so that an average value of the doubled value (ΔR)² is calculated. Then, d² is estimated in place of the distance d, and a square root of the estimated d² is calculated. The displacement amount d can be obtained in this manner.

In the foregoing description, the displacement amount R is estimated based on the radius value of the track (distance R); however, it is not possible to directly obtain the accurate radius value of a track itself in many optical disc devices. Therefore, the radius value of the track (distance R) may be calculated from an address value (value of the physical address currently read) in the devices thus constituted. Below is described an example of a method for converting the address value into the radius value of the track (distance R).

Provided that the length of a unit to which the address value is given (conventionally, by each sector) is L, a known address value of a known radius value (distance R₀) is A₀ (conventionally, defined, for example, as an innermost-peripheral position and an address value, etc. in the written standards of the optical disc), a current address value is A, and a track pitch is Tp, the current radius value (distance R) is calculated by the following formula (8).

R=SQRT(Tp·L·(A−A₀)/π+R₀²) (8)

In a similar manner, the number of tracks N from the address A₀ to the address A can be calculated by the following formula 9).

N=R/Tp=SQRT(Tp·L·(A−A₀)/π+R₀²)/Tp (9)

The calculating process of the radius value (distance R) or the number of the tracks from the address value is a part of processes necessary for calculating the number of the tracks traversed from the address value at which the search starts to the searched address value (corresponding to the N mentioned earlier), and is conventionally executed in optical disc devices. Therefore, the method of calculating the radius value (distance R) from the address value is not limited to the example described above, and any method may be adopted as far as an equal result is obtained. Conversely, based on a relationship between the radius value (distance R) and the address value, the address value A can be calculated from the radius value (distance R). Therefore, the address values in the tracks having radius values (distance R+D) and (distance R−d), which are obtained when the radius value (distance) of an arbitrary track (for example, radius value (distance R) is changed depending on the displacement amount d, can also be calculated.

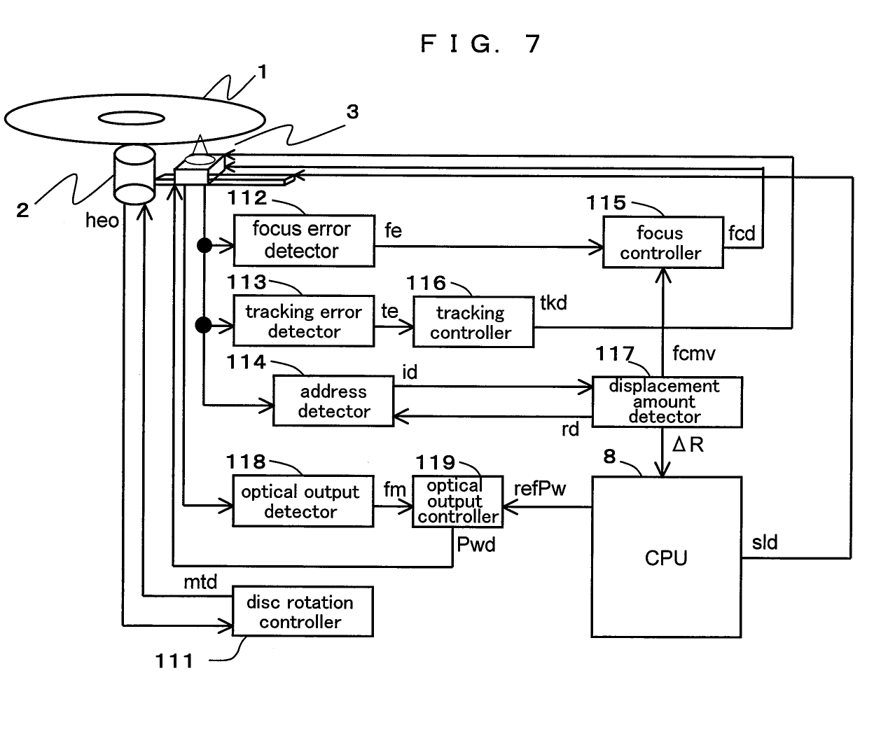

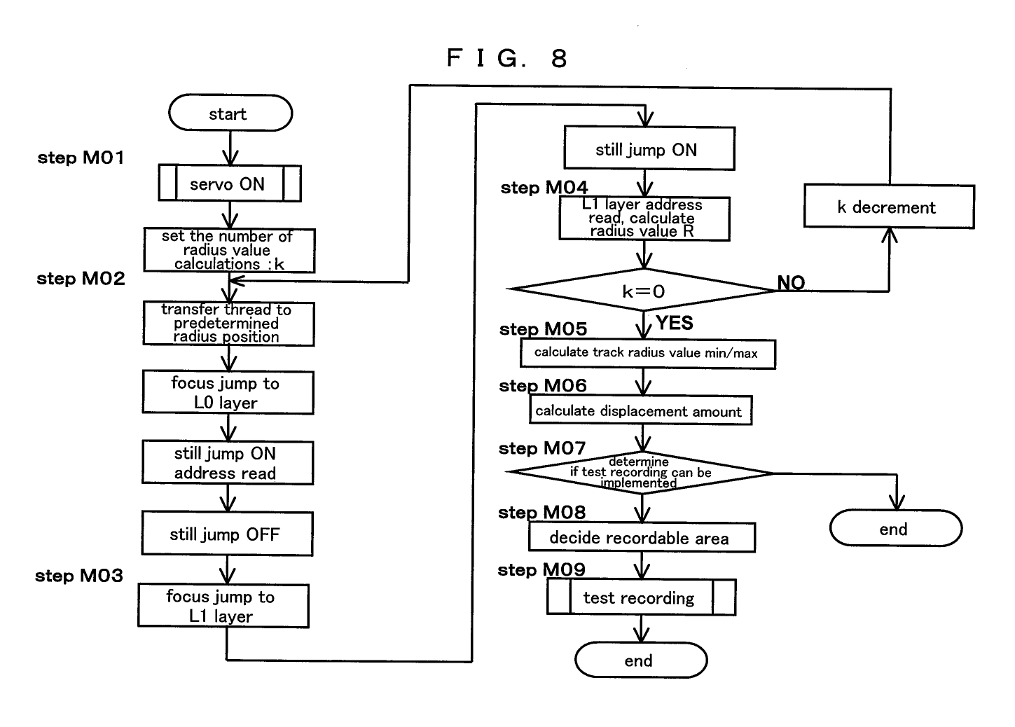

Based on the description given so far, an optical disc device which calculates the displacement amount d from the address value after the inter-layer jump and a method for calculating the displacement amount are described referring to FIGS. 7 and 8.

FIG. 7 is a block diagram illustrating an optical disc device capable of calculating the displacement amount d from the address value. The structural elements provided with the same reference symbols as those shown in FIG. 1 will not be described in detail.

An optical disc 1 is a DVD-R disc comprising two recording layers. A spindle motor 2 which rotates the optical disc 1 at a predetermined number of rotations outputs a rotation position signal heo.

A disc rotation controller 111 calculates a rotation rate of the spindle motor 2 based on the rotation position signal heo supplied from the spindle motor 2, and outputs a control output mtd to the spindle motor 2 so that a targeted number of rotations is obtained.

An optical pickup 3 comprises a function for irradiating light beam on the optical disc 1 and condensing and detecting reflected light. The optical pickup 3 comprises a condensing lens (not shown) and an actuator for driving the condensing lens (not shown). The optical pickup 3 comprises a function for condensing the light beam at an arbitrary position along a direction vertical to a recording surface of the optical disc 1 (hereinafter, referred to as focus direction) and a function for condensing the light beam at an arbitrary position along a track-traversing direction on the optical disc 1 (hereinafter, referred to as track direction).

Below are described operations of the respective structural elements of the optical disc device in further detail. The optical pickup 3 outputs a signal obtained when a part or all of the reflected light is converted into an electrical signal to a focus error detector 112, a tracking error detector 113 and an address detector 114.

The focus error detector 112 detects a position displacement amount in the vertical direction between the condensed light beam and the recording surface of the optical disc 1, and generates a focus error signal fe based on a result of the detection and outputs the generated signal to a focus controller 115.

Based on the focus error signal fe, the focus controller 115 generates a drive signal fed obtained when the focus error signal fe is controlled to be zero, and outputs the generated signal to the actuator of the optical pickup 3. When the inter-layer jump which moves the position at which the light beam is condensed to an arbitrary recording layer of the optical disc 1 is driven, the focus controller 115 controls the drive of the inter-layer jump.

The tracking error detector 113 detects a position displacement amount between the condensed light beam and an arbitrary track position on the optical disc 1, and generates a tracking error signal te based on a result of the detection and outputs the generated signal to a tracking controller 116.

Based on the tracking error signal te, the tracking controller 116 generates a drive signal tkd obtained when the tracking error signal te is controlled to be zero, and outputs the generated signal to the actuator of the optical pickup 3. When a still jump which determines the position of the light beam condensed on the arbitrary track of the optical disc 1 is driven, the tracking controller 116 controls the drive.

The address detector 114 detects the physical address by detecting LPP (Land Pre-Pit) recorded on the optical disc in advance and the like based on the reflected light from the optical disc 1. The address detector outputs a result id to a displacement amount detector 117. The result id is address information indicating at which position on the optical disc 1 the light beam is condensed based on a read instruction rd from the displacement amount detector 117. Hereinafter, the address information is called id.

The displacement amount detector 117 outputs an inter-layer jump instruction fcmv to the focus controller 115. The inter-layer jump instruction fcmv is an instruction signal which controls the transfer of the position where the light beam is condensed to a predetermined recording layer on the optical disc 1. The displacement amount detector 117 calculates the radius value (distance R) where the light beam is condensed based on the address information id outputted from the address detector 114. The displacement amount detector 117 detects the displacement amount ΔR from the radius value (distance R) calculated in each of the respective recording layers (L0 layer and L1 layer) and outputs a result of the detection to the CPU 8.

The CPU 8 outputs a drive signal sld to the thread 4. The drive signal sld is a signal which controls the transfer of the optical pickup 3 to a predetermined position in the radial direction of the optical disc 1. The thread 4 transfers the optical pickup 3 to the predetermined position in the radial direction of the optical disc 1 based on the drive signal sld. The CPU 8 can output an optical output targeted value refPw to an optical output controller 119. The output targeted value refPw will become necessary when data is recorded on and reproduced from the optical disc 1.

An optical output detector 118 detects a level of the optical output irradiated on the optical disc 1, and converts a result of the detection into an electrical signal fm. The optical output detector 118 detects the optical output level by detecting at least a part of the light beam outputted by an irradiator of the optical pickup 3. The electrical signal fm is supplied to the optical output controller 119. The optical output controller 119 generates an optical output control signal Pwd by controlling a difference between the optical output targeted value refPw and the electrical signal fm (optical output level) to be as close to zero as possible, and outputs the generated signal to the irradiator of the optical pickup 3. The optical pickup 3 is transferred based on the drive signal sld outputted from the CPU 8, and the CPU 8 then controls the drive signal sld so that the following conditions are satisfied.

The displacement amount d can be detected by the displacement amount detector 117 at an arbitrary radius position on the optical disc 1.

The data can be recorded on an arbitrary track of the optical disc 1.

The information previously recorded on the arbitrary track of the optical disc 1 can be reproduced.

Further, the CPU 8 controls the optical output targeted value refPw so that the following conditions are satisfied.

An arbitrary recording mark can be formed on the optical disc 1 by the optical output controller 119 and the optical output detector 118.

The information previously recorded on the optical disc 1 can be reproduced.

Referring to FIG. 8, the method of obtaining the displacement amount d is described in further detail. FIG. 8 is a flow chart illustrating steps of obtaining the displacement amount d in the optical disc device 1 illustrated in FIG. 7. First, a servo control of the light beam condensed on an arbitrary track of the optical disc 1 starts (Step M01). Next, a predetermined arbitrary address on the L0 layer is searched, and the still jump is performed (Step M02). Then, the inter-layer jump to a random position on the same track is performed so that a current address on the L1 layer which is the destination of the inter-layer jump is obtained (Step M03), and the radius value (distance R) is calculated by, for example, the formula (1).

Steps M01-M04 are repeated a plurality of times, so that the maximum value Rmax and the minimum value Rmin of the radius value (distance R) are calculated (Step M05). Then, the maximum value Rmax and the minimum value Rmin are assigned to the formula (2) so that the displacement amount d is calculated (Step M06).

After the calculation of the displacement amount d, it is determined whether or not the test recording is implemented to the non-usable area in advance in accordance with the displacement amount d (Step M07). In the case where the test recording is implemented, the recordable area is decided (Step M08), and the test recording is implemented there (Step M09). The displacement amount detector 117 is in charge of Steps M04 and M06, while the CPU 8 is in charge of Step M09. The CPU 8 in charge of the step functions as a recordable area identifying unit. Further, the CPU 8 functions as a determiner, first and second searchers, and first and second confirmers.

According to the description earlier, the destination of the inter-layer jump is the random position in Step M03. However, the number of times Steps M01-M04 are repeated can be reduced when the inter-layer jump is performed in circumferential predetermined intervals (substantially at equal intervals) on the track in comparison to the random position inter-layer jump.

Below are given supplemental remarks on the handling of the address value. In an opposite track path (OTP) in the DVD bilayer disc including the DVD-R Dual Layer disc, the disc is designed so that bits are inverted between an address value of a radius value (distance R) on the L0 layer and an address value of the same radius value (distance R) as that of the L0 layer on the L1 layer. Therefore, the address value increases from the inner-peripheral side to the outer-peripheral side in one of the layers, while the address value increases from the outer-peripheral side to the inner-peripheral side in the other. In the disc thus constituted, in the case where the address value in one of the layers is inverted, and the inverted address value is substantially equal to the address value in the other layer, the address values of the two layers are at positions having substantially an equal radius value (distance R).

The method of calculating the radius value (distance R) from the address value was described earlier. In the description, the specific calculation method illustrated as an example was described referring to the layer where the address increased from the inner-peripheral side to the outer-peripheral side. In the case of the layer where the address increases from the outer-peripheral side to the inner-peripheral side, on the contrary, the address value actually read is bit-inverted, and the inverted address value is regarded as the address value. Then, the radius value (distance R) can be calculated in the same manner as described earlier.

In the description so far, an amount of time necessary for the inter-layer jump was disregarded as substantially zero. However, the inter-layer jump actually requires a very small amount of time (for example, approximately 10 ms). In a period of time when the inter-layer jump is carried out, the optical disc device is not subject to the tracking control, and the track displacement accordingly occurs during the period. Hereinafter, the track displacement thus caused is referred to as a track drift. The track drift generates a control error.

As an angle through which the optical disc 1 is rotated is increased during the inter-layer jump, the track drift increases to such a level that cannot be ignored in view of the control error. Further, a maximum surface-wobbling rate of the optical disc 1 is increased in proportion to the rotation rate of the optical disc 1. Therefore, the possibility that a focus pull-in during the inter-layer jump may fail increases as the track drift increases. The focus pull-in is to accurately shift the light spot to a desired track of the destination layer when the light spot transfers from the L0 layer to the L1 layer or from the L1 layer to the L0 layer.

In order to lessen the track drift so that such an inconvenience is prevented, the rotation rate of the optical disc 1 should be reduced to a minimum level. When data is recorded on and reproduced from DVD in a conventional optical disc device, various control processes are executed at a linear speed higher than a standard linear speed (normal speed). The time length of approximately 40 ms is necessary per one rotation in a PAC area on the inner-peripheral side in the case where the DVD-R optical disc 1 is rotated at the standard linear speed (normal speed). Therefore, in the case where 10 mn, for example, is necessary for the inter-layer jump, the track drift which occurs during the inter-layer jump corresponds to 90-degree rotation. Assuming a case where an allowable error as the track drift during the inter-layer jump is, for example, approximately 30 degrees when the operation of the optical disc is controlled, the inconvenience described earlier can be prevented from happening when the optical disc 1 is rotated at a ⅓ speed (0.33 speed) or lower.

However, in the case where the rotation rate of the optical disc 1 is at most the standard speed (1×), it is necessary to reduce the power of the laser beam for reproducing data irradiated from the optical pickup 3. Otherwise, the disc would be exposed to the laser beam during the reproduction, and the data is thereby recorded thereon.

In order to reduce the power of the reproduction laser beam, the power of the reproduction laser beam irradiated from the optical pickup 3 itself may be reduced as described earlier, or such an inconvenience can be prevented when the displacement amount d of the track is measured on the peripheral side as outer side as possible (inter-layer jump). In the case where the disc is rotated at the standard linear speed (normal speed), for example, the time length of approximately 100 ms is necessary for one 360-degree rotation at an outermost peripheral position on the disc. Assuming that 10 ms, for example, is necessary in the inter-layer jump at the outermost peripheral position of the disc, the track drift which occurs during the inter-layer jump is 36-degree rotation, which is a significantly reduced amount in comparison to the track drift (90-degree rotation) which occurs when the displacement amount d is measured on the inner-peripheral side of the disc. When the displacement amount d is thus measured (inter-layer jump) on the peripheral side as outer side as possible, the track drift during the inter-layer jump can stay within an allowable error range in the case where the disc rotation rate at the time is substantially equal to the standard linear speed (normal speed).

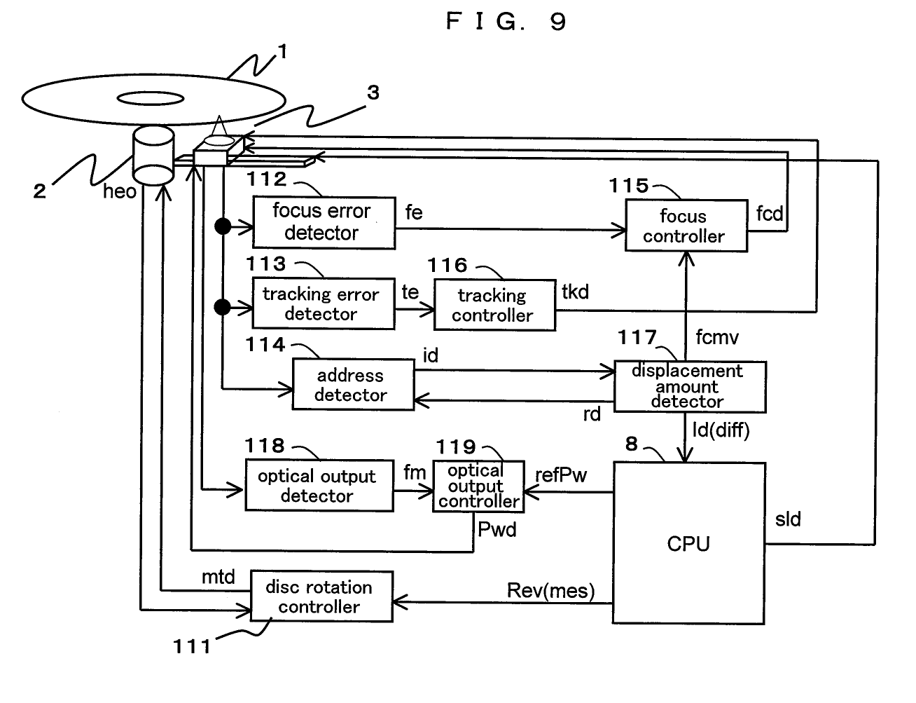

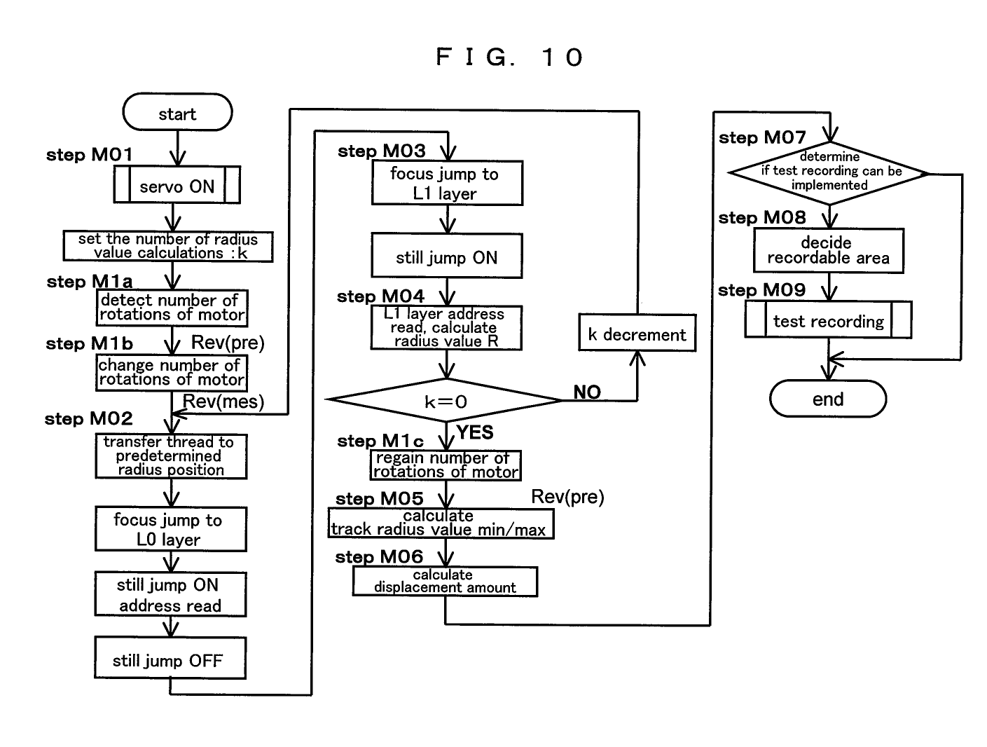

Next, a structure example of the optical disc device where the displacement amount d can be measured (inter-layer jump) in a state where the rotation rate of the optical disc 1 is lowered is described referring to FIG. 9. In the optical disc device illustrated in FIG. 9, the optical disc device illustrated in FIG. 7 is improved so that a rotation number change instruction Rev (mes) is supplied from the CPU 8 to the disc rotation controller 111. In the optical disc device illustrated in FIG. 9, the rotation rate of the spindle motor 2 is significantly reduced during the measurement of the displacement amount d based on the assumption that the time length necessary for the inter-layer jump cannot be disregarded. More specifically, as illustrated in FIG. 10, Step Mia and Step M1b are additionally included between Step M01 and Step M02 in the flow chart illustrated in FIG. 8, and Step M01c is additionally included to between Step M04 and Step M05.

In Step M1a, the number of rotations of the spindle motor 2 is detected, and a result of the detection is memorized as Rev (pre). In Step M1b, a motor targeted rotation number Rev (mes) is controlled so that a rotation cycle (time length necessary for 360-degree rotation) of the spindle motor 2 is significantly larger than the time required for the inter-layer jump. In Step Inc, the number of rotations of the spindle motor 2 is changed back to the Rev (prey) measured in Step M1a after Step M04 for calculating the radius value (distance) R.

When the control operation is improved as illustrated in the flow chart of FIG. 10, the focus pull-in which occurs when the light spot moves from the L0 layer to the L1 layer or from the L1 layer to the L0 layer in the inter-layer jump can be stabilized and the measurement error generated by the track drift can be reduced.

The description given so far was based on the jump from the L0 layer to the L1 layer; however, the jump from the L1 layer to the L0 layer can be similarly handled, and the displacement amount d can be calculated in a similar approximation expression. Thus, the displacement amount d can be calculated based on the radius value or the address value after the inter-layer jump from the L1 layer to the L0 layer.

So far were described various calculation methods; however, the steps according to the present preferred embodiment are not limited to those calculation methods. Any calculation method by which an effect similar to those obtained by the before-mentioned calculation methods can be easily anticipated by the ordinarily skilled in the art may be adopted instead.

### Second Example of the Detailed Steps

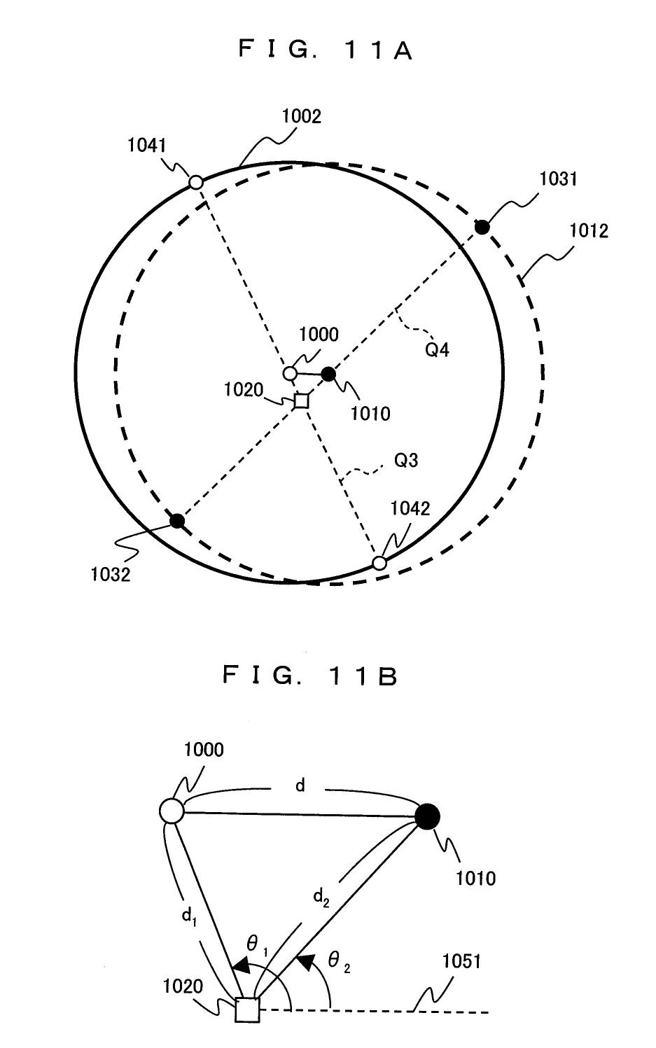

Below is described a second example of the detailed steps of calculating the displacement amount d. FIG. 11A is an illustration of tracks of the L0 layer and the L1 layer of the optical disc 1. 1000 denotes a center point of a track 1002 of the L0 layer, and a center point 1010 is a center point of a track 1012 of the L1 layer. 1020 denotes a rotation center of the disc 1. The position of the rotation center 1020 is randomly decided every time the optical disc 1 is loaded in the optical disc device E and thereby chucked. 1041 and 1042 respectively denote points at which a straight line Q3 which connects the rotation center 1020 and the center point 1000 to each other and the track 1002 intersect with each other. The intersecting point 1041 is farther than the intersecting point 1042 from the rotation center 1020. 1031 and 1032 respectively denote points at which a straight line Q4 which connects the rotation center 1020 and the center point 1010 to each other and the track 1012 intersect with each other. The intersecting point 1031 is farther than the intersecting point 1032 from the rotation center 1020.

FIG. 11B is an enlarged view of a main section illustrated in FIG. 11A, which specifically illustrates a positional relationship among the center point 1000, center point 1010 and rotation center 1020. In the drawing, d denotes a distance between the center point 1000 and the center point 1010. d₁ denotes a distance between the center point 1000 and the rotation center 1020. d₂ denotes a distance between the center point 1010 and the rotation center 1020. 1051 denotes a reference line passing through the rotation center 1020. θ₁ denotes an angle formed between the line segment Q3 and the reference line 1051. θ₂ denotes an angle formed between the line segment Q4 and the reference line 1051. The reference line 1051 may be drawn in any manner as far as it passes through the point 1020 because a parameter rotation angle θ finally necessary for the calculation is calculated by the following formula (10).

θ=ABS(θ₁−θ₂) (10)

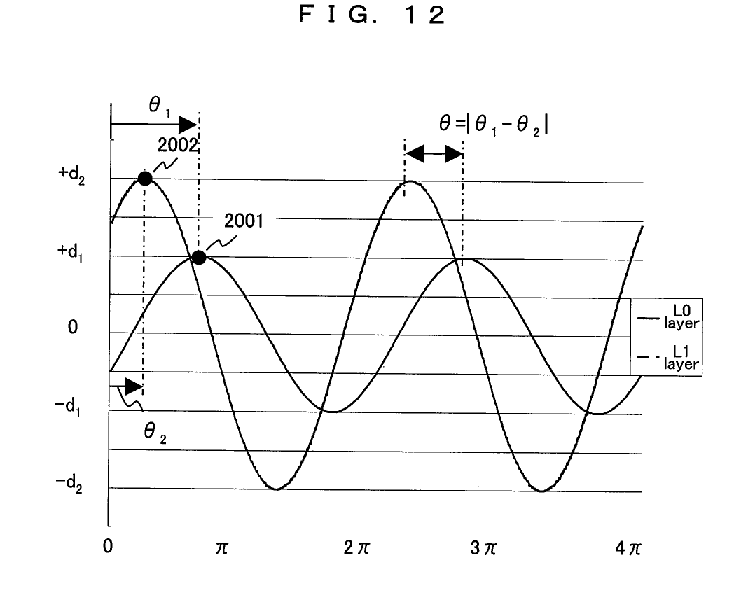

FIG. 12 illustrates a state where the lens position of the optical pickup 3 (tracking direction) varies as the optical disc 1 is rotated when the respective layers (L0 layer and L1 layer) follow the tracks (tracking control). In FIG. 12, reference symbols with plus of the variation denote the outer-peripheral side, while reference symbols with minus denote the inner-peripheral side. Further, 0 (zero) denotes the center of the variation. The variation of the lens position illustrated in FIG. 12 is calculated, for example, as follows.

The tracking control is performed mainly to absorb the rotational variation generated by a difference between the rotation center 1020 and the actual center of the track (center point 1000 or 1010). In the tracking control, the variation is calculated based on a value obtained when a drive amount of the lens of the optical pickup 3 in the tracking control is integrated (more specifically, an estimated value of an amount of the movement due to driving), or calculated based on a low-frequency component of the tracking error signal used for the tracking control. In many optical disc devices, a processing in which the variation illustrated in FIG. 12 is measures so that an amount of eccentricity (that is, an amount corresponding to d₁ or d₂ in FIG. 12) is calculated is conventionally executed. With this in view, the process conventionally executed is utilized in the present preferred embodiment so that the variation can be calculated without any additional process. However, the variation is not necessarily calculated as described earlier, and any calculation method may be employed as far as an equal result can be obtained.

The rotation rate of the optical disc 1 may be defined as constant for at least a short period of time (when the disc is rotated at a few times or a few-hundred times), during which time S necessary for one 360-degree rotation of the disc is regarded as substantially constant. Provided that a time interval for obtaining the measured value in order to obtain the variation illustrated in FIG. 12 (sampling interval, or plot interval in terms of a graph) is T, the number of times the measured value is obtained (sampling frequency) as the disc is rotated through 360 degrees once is S/T times.

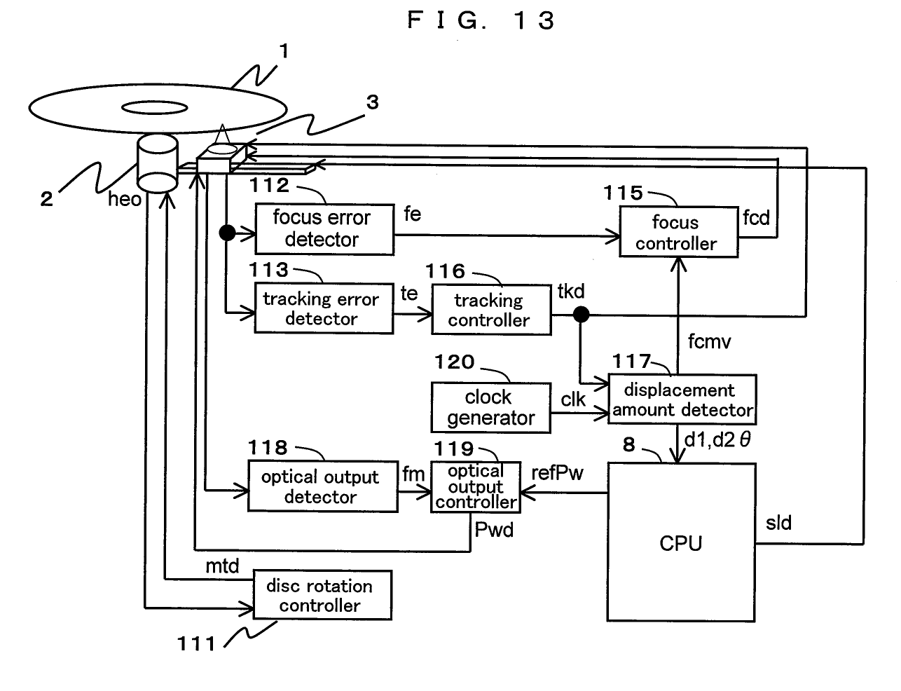

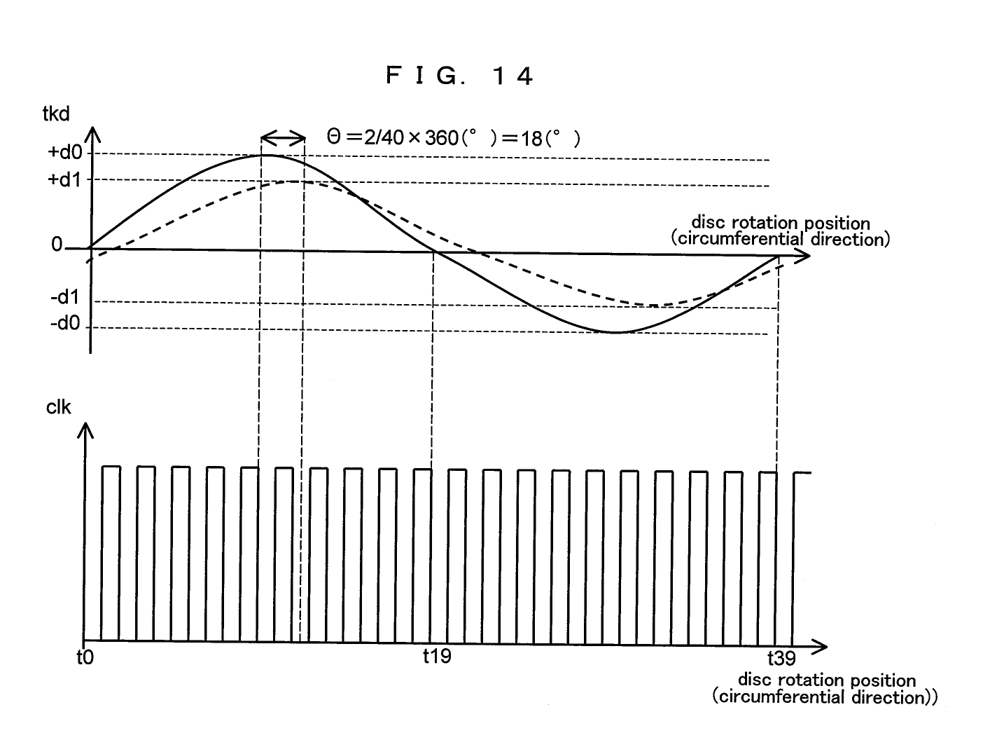

Next, a structure of an optical disc device capable of calculating the displacement amount d based on the amount of eccentricity (d₁ or d₂ in FIG. 12) calculated as described earlier and a calculation method thereof are described below referring to FIGS. 13 and 14.

FIG. 13 is a block diagram illustrating the structure of the optical disc device capable of calculating the displacement amount d based on the amount of eccentricity. The structural elements provided with the same reference numerals as those shown in FIG. 7 will not be described in detail. The tracking error detector 113 detects a position displacement amount between the condensed light beam and an arbitrary track position on the optical disc 1 to thereby generate a tracking error signal te, and outputs the generated signal to the tracking controller 116. Based on the tracking error signal, the tracking controller 116 controls a calculation to make the tracking error signal te zero, thereby generate a drive signal tkd, and outputs the generated signal to the actuator of the optical pickup 3 and the displacement amount detector 117. As described referring to FIG. 7, the tracking controller 116 can execute the still jump drive control so that the position of the light beam condensed on an arbitrary track on the optical disc 1 can be decided.

A clock generator 120 generates and outputs an output clk which is a pulse signal having a constant frequency obtained when an output of an element which outputs a constant frequency signal is frequency-divided. A quartz transmitter, for example, constitutes the clock generator 120. The clock generator 120 outputs the output clk to a displacement amount detector 117.

The displacement amount detector 117 samples the drive output tkd from the tracking controller 116 using a sampling frequency set based on the output clk from the clock generator 120 to thereby measure a value corresponding to the eccentricity with reference to a circumferential position on the optical disc 1. The displacement amount detector 117 measures the value in each of the recording layers of the optical disc 1 and detects the displacement amount d based on the information of the eccentricity of each of the recording layers thus obtained. Below is described the detection method of the displacement amount d.

FIG. 14 is an illustration of the output of the tracking controller 116 and the output of the clock generator 120 at the time when the optical disc 1 is rotated in the optical disc device illustrated in FIG. 13. In the drawing, a horizontal axis denotes a circumferential rotation position of the optical disc 1, and a vertical axis denotes the output tkd of the tracking controller 116 and the output clk of the clock generator 120. In FIG. 14, the output tkd of the tracking controller 116 in the L0 layer is shown in a solid line, while the output tkd of the tracking controller 116 in the L1 layer is shown in a broken line. As described earlier referring to FIG. 12, when the optical disc 1 is rotated, the tracking controller 116 outputs a drive signal having a cosine wave shape illustrated in FIG. 14 in order to follow the eccentricity of the optical disc 1. When the amount of eccentricity of the optical disc 1 is increased, the amplitude of the tracking control output tkd shown in the vertical axis is increased. The displacement amount detector 115 samples the output tkd of the tracking controller 116 at timings of the rise and fall of the output clk. The displacement amount detector 115 executes the measurement (sampling) in a period corresponding to at least one rotation, and then, detects a sample whose output tkd of the tracking controller 116 shows a largest value as a maximum value output sample and accordingly detects the output tkd of the maximum value output sample as a maximum value. In FIG. 14, the maximum value output sample of the tracking controller 116 in the L0 layer is t10, and the maximum value is +d0. In a similar manner, the maximum value output sample of the tracking controller 116 in the L1 layer is t12, and the maximum value is +d1.

When the respective data illustrated in FIG. 14 are assigned to the formula 1), the displacement amount d is calculated as follows. In the following formula (1-1), the respective data illustrated in FIG. 14 are assigned to the formula 1).

d=SQRT(d0²+d1²−2d0·d1·cos(θ)) (1-1)

However, θ in the formula (1-1) is obtained in the following formula 12).

θ(deg)=2π2/40=18(deg) (12)

The constant (2/40) in the formula 12) is thus set because an absolute value of a difference between the samplings in which the amount of eccentricity shows a largest value in the L1 and L0 layers (t10 and t12) is 2, and the total number of the samplings by the displacement amount detector 117 is 40 in an interval in which the optical disc 1 is rotated through 360 degrees once. The description refers to the example in which the output tkd of the tracking controller 116 is sampled by the sampling frequency corresponding to approximately 40 samples per one 360-degree rotation of the disc; however, the sampling is not necessarily limited to such a sampling frequency. As the sampling frequency is increased, the displacement amount d can be more accurately calculated.

As described referring to FIG. 7, the displacement amount detector 117 can output an inter-layer jump instruction fcmv to the focus controller 115 in order to transfer the position where the light beam is condensed to an arbitrary position on the optical disc 1.

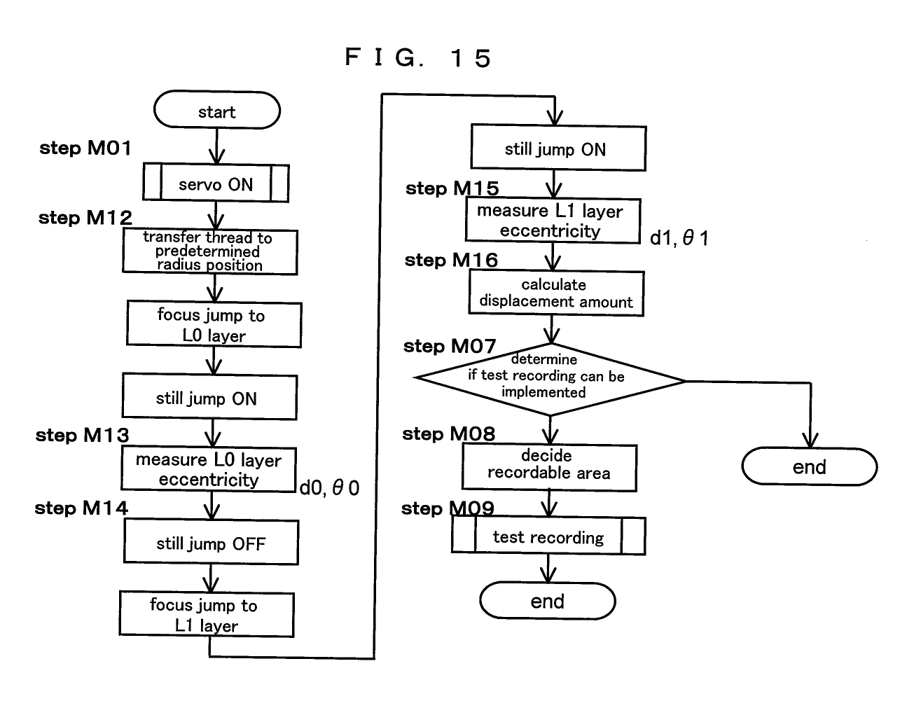

Next, the method of calculating the displacement amount d is described referring to FIG. 15. FIG. 15 is a flow chart illustrating steps of calculating the displacement amount d in the optical disc device illustrated in FIG. 13. First, the control of the light beam condensed on an arbitrary track of the optical disc 1 starts (servo ON: Step M01). Then, an arbitrary address previously decided on the L0 layer is searched so that the light spot is still-jumped to the searched address (Step M12). Based on the drive output tkd of the tracking controller 116 and the output clk of the clock generator 120 on the track, the maximum value d0 corresponding to the eccentricity and a timing θ0 by which the maximum value d0 is sampled are measured (Step M13). The still jump is then released (still jump OFF), and an interlayer jump is made to the L1 layer, where the still jump restarts (still jump ON: Step M14). In a manner similar to Step M13, the maximum value d1 corresponding to the eccentricity and a timing 80 by which the maximum value d1 is sampled are measured in the L1 layer (Step M15) based on the drive output tkd of the tracking controller 116 and the output clk of the clock generator 120. Then, the displacement amount d is calculated based on the measurement results obtained in Steps M13 and M15 (d0, d1, θ0 and θ1) (Step M16).

The displacement amount d can be calculated when Steps M11 to M16 are thus implemented. After the displacement amount d is obtained, it is determined whether or not the test recording is previously executed to the non-usable area depending on the displacement amount d (Step M07). In Step M07, for example, it may be determined that the test recording is not executed to the non-usable area when the displacement amount d is relatively large. When it is determined in Step M07 that the test recording is implemented, the test recording is implemented to the non-usable area. More specifically, a usable area is decided (Step M08), and the test recording is implemented in the usable area thus decided (Step M09). Step M07 may be omitted so that the operation always starts from Step M08, then to Step M09.

The cos (θ) in the formula (1-1) may be calculated as follows. A table in which a difference between a sampling position in one of the recording layers where the output tkd of the tracking controller 116 shows a largest value and a sampling position in the other recording layer is used as an argument is set and memorized in advance, and the cos(θ) may be calculated referring to the table in the actual processing. In the case where the track radius and the linear speed at the time of the measurement are set in advance, a value of a total sampling number S per each 360-degree rotation is naturally decided. Therefore, the table can be prepared in advance.

In the foregoing description, the variation illustrated in FIG. 12 was calculated based on the difference in position between the maximum variation point and the reference timing in one 360-degree rotation of the disc (zero position in FIG. 12); however, the minimum variation point may be used in place of the maximum variation point. Further, the minimum variation point and the maximum variation point may be both used so that the calculation can be more accurate. For example, when the value of maximum variation point in the L0 layer is d₁max and the value of the minimum variation point is d₁min, the maximum value d₁ may be calculated as d₁=(d₁max−d₁min)/2, or the minimum value may be calculated from (d₁min−d₁max)/2. Thus constituted, in the case where the variation is measured with the center of the variation being displaced from zero (with a certain offset amount), in particular, any influence from the offset amount can be cancelled.

The foregoing description was based on the jump from the L0 layer to the L1 layer; however, the displacement amount d can be calculated in a similar manner in the case of the jump from the L1 layer to the L0 layer.

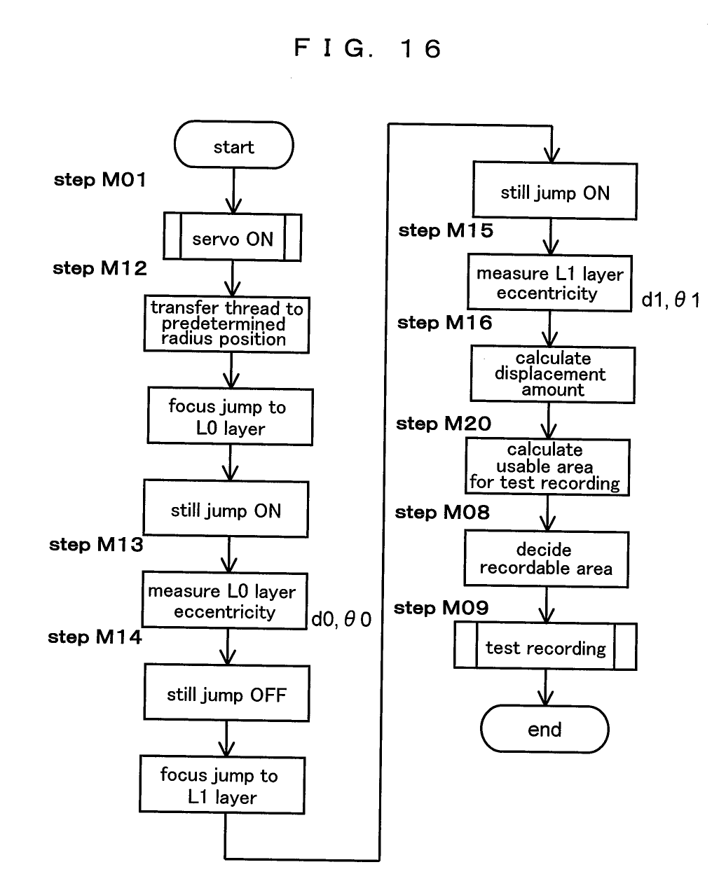

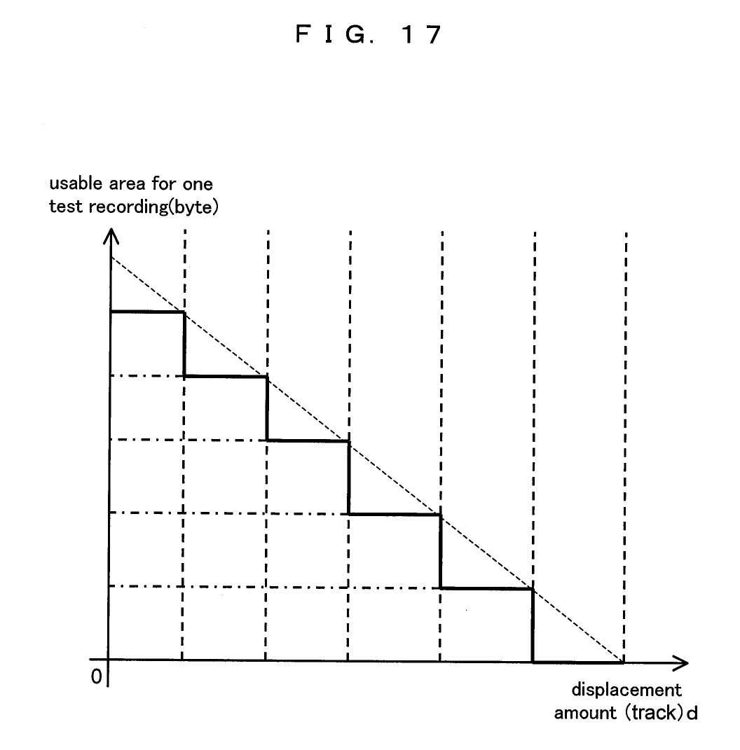

In the optical disc device according to the present invention, the area previously defined as the non-usable area can be used as the test recording area, and additional writing can be reliably executed as frequently as desired. Further, according to the optical disc device according to the present invention, additional writing can be reliably executed as frequently as desired in the optical disc where the displacement amount is relatively large when the position and dimension of the recording area used for one test recording are decided depending on the displacement amount d calculated as described earlier. Referring to FIGS. 16 and 17, a preferred embodiment of the present invention illustrating a specific method is described. FIG. 16 is a flow chart illustrating steps of calculating the displacement amount d in the optical disc device illustrated in FIG. 13 as in the case with FIG. 15. The displacement amount detecting method illustrated in FIG. 16 is the same as the displacement amount detecting method illustrated in FIG. 15 up to Step M16; however, after the displacement amount d is detected in Step 16, a process in which the recording area used for one test recording is decided depending on the detection result thus obtained (M20) is added, in which point, FIG. 16 is different to FIG. 15.

Referring to FIG. 17, a relationship between the displacement amount d and the recording area used for one test recording in the present preferred embodiment is described. In FIG. 17, a horizontal axis denotes the displacement amount d (track is used as unit), and a vertical axis denotes the recording area usable for one test recording (byte is used as unit). The optical disc device according to the present preferred embodiment controls the operation in the following ways:

1. The recording capacity usable for one test recording is increased as the displacement amount d is lessened (closer to zero (track)).
2. The recording capacity usable for one test recording is reduced as the displacement amount d is larger.

In the control described above, the recording capacity usable for one test recording and the displacement amount d may be controlled to be inversely proportional to each other as shown in a broken line in FIG. 17.

When data is recorded on the optical disc, it is difficult to realize a completely inversely proportional relationship as shown in the broken line because there is generally a minimum recording unit. Therefore, the recording capacity and the displacement amount d may be controlled based on an arbitrary recording unit depending on the displacement amount d as shown in a solid line, in other words, may be controlled in the inversely proportional manner stage by stage, or the recording capacity usable for one test recording may be changed depending on the purpose of the test recording. The following purposes may be set as the highest-priority purposes for test recording by the optical disc device.

1. to decide an optical output or a write strategy necessary for the formation of a recording mark when information is recorded on the optical disc,
2. to decide electric circuit characteristics for reproducing the information recorded on the optical disc,
3. to execute a servo process for accurately condensing the light beam on an arbitrary track of the optical disc.

Then, the test recording is implemented so that:
the objects with higher priorities are achieved as the displacement amount d is larger.
the objects with lower priorities are achieved as the displacement amount d is smaller.

Then, additional writing can be executed to the optical disc as frequently as desired irrespective of the size of the displacement amount d.

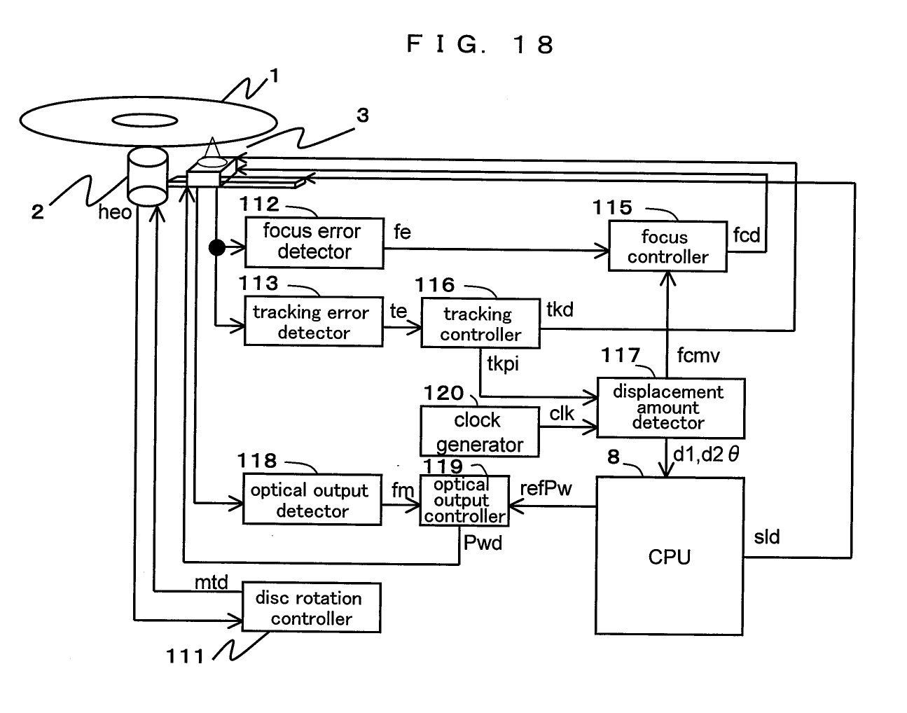

In FIG. 13, the amount of eccentricity of the optical disc 1 was calculated from the drive output tkd of the tracking controller 116. As illustrated in FIG. 18, the tracking controller 116 may extract only the low-frequency component included in the output to of the tracking error detector 113 (in FIG. 18, tkpi denotes the low-frequency component) and input the extracted low-frequency component to the displacement amount detector 117. In such a way, the displacement amount can be apparently detected as in the case with the displacement amount detection method according to the present preferred embodiment described referring to the device structure illustrated in FIG. 13 and the flow chart illustrated in FIG. 15.

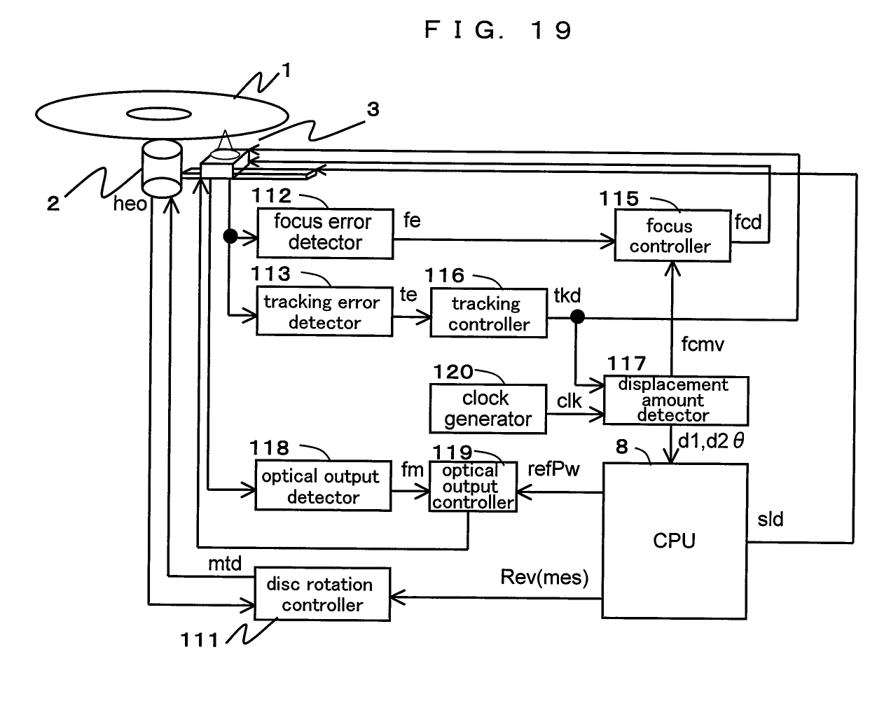

As described earlier referring to FIGS. 9 and 10, in the present invention, the measurement is less accurate in the case where the frequency of the spindle motor 2 is not significantly smaller (is relatively large) with respect to the output clk of the clock generator 120. In order to deal with the disadvantage, the number of rotations of the spindle motor 2 is reduced to a certain level previously set when the displacement amount d in each of the respective recording layers is detected as illustrated in FIG. 19. As a result, the measurement can retain a high accuracy.

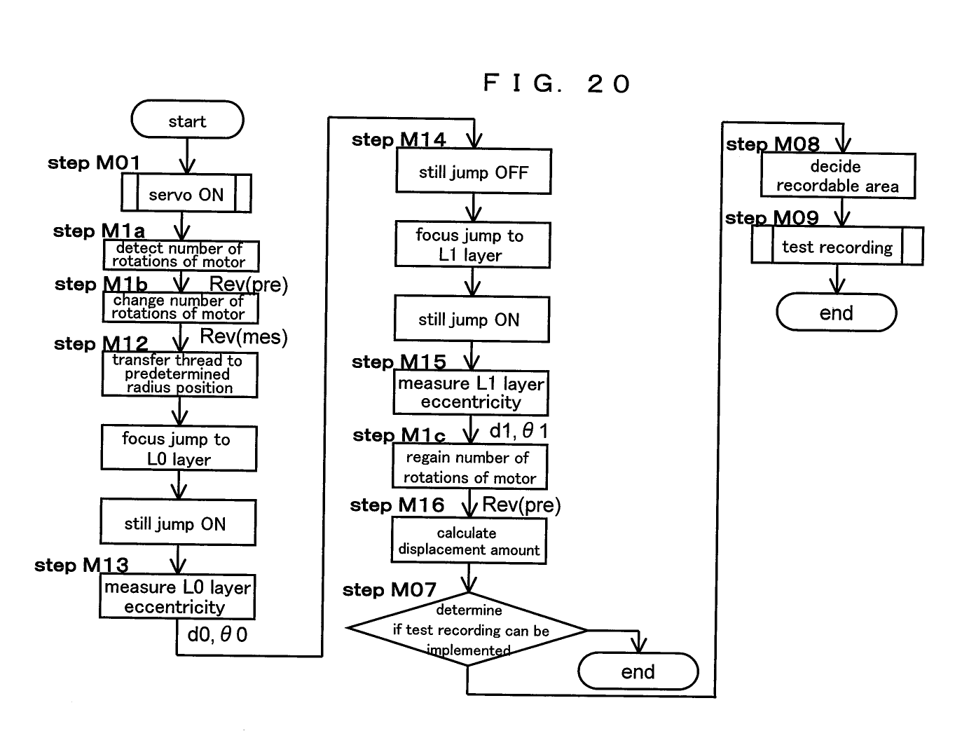

In the optical disc device illustrated in FIG. 19, the CPU 18 supplies the rotation number change instruction Rev (mes) to the disc rotation controller 111 in the optical disc device illustrated in FIG. 13. The reason for this is described below. The cycle of the output clk of the clock generator 120 may become occasionally so large relative to the rotation cycle of the optical disc 1 that it cannot be disregarded. In order to deal with the possible case, the rotation of the spindle motor 2 is significantly lowered during the step of measuring the displacement amount d in the optical disc device illustrated in FIG. 19. More specifically, as illustrated in a flow chart of FIG. 20, a process in which the number of rotations of the spindle motor 2 is detected and memorized as Rev (pre) (Step M1a) and a process in which the motor targeted rotation number Rev (mes) is controlled to control the rotation cycle of the spindle motor 2 so that the rotation cycle of the spindle motor 2 is significantly larger than the period necessary for the inter-layer jump (Step M1b) are further included between Step M-1 and Step M-2 in the flow chart illustrated n FIG. 15. Further, a process in which the number of rotations of the spindle motor 2 is changed back to Rev (pre) measured in Step M1a is executed after Step M4 for measuring the amount of eccentricity in the L1 layer is completed. Thus constituted, the sampling time for measuring the amount of eccentricity can be long enough, and the displacement amount can be more accurately detected.

In the respective preferred embodiments described so far, the displacement amount d is detected in the state where the tracking controller 116 condenses the light beam on an arbitrary track of the optical disc 1 (tracking control state).

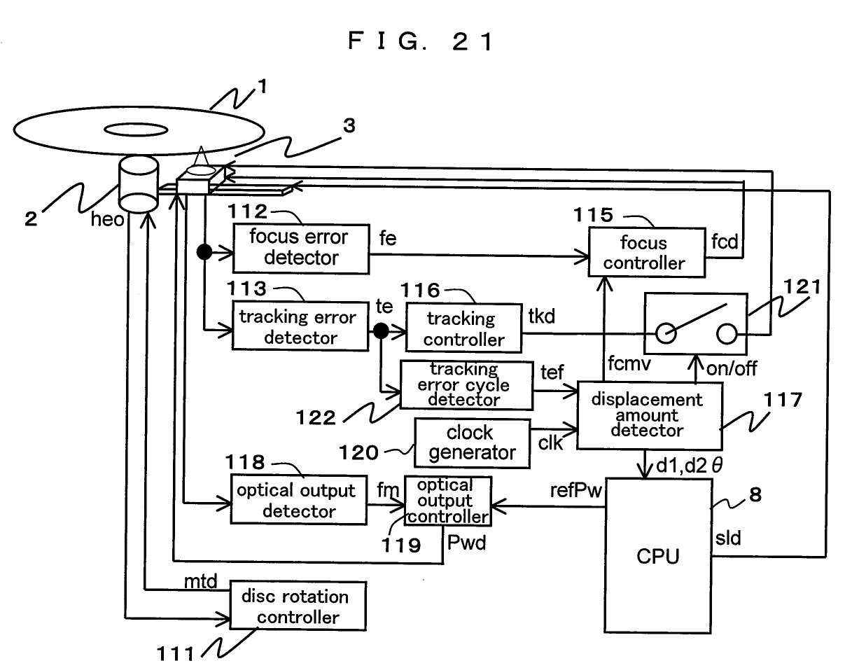

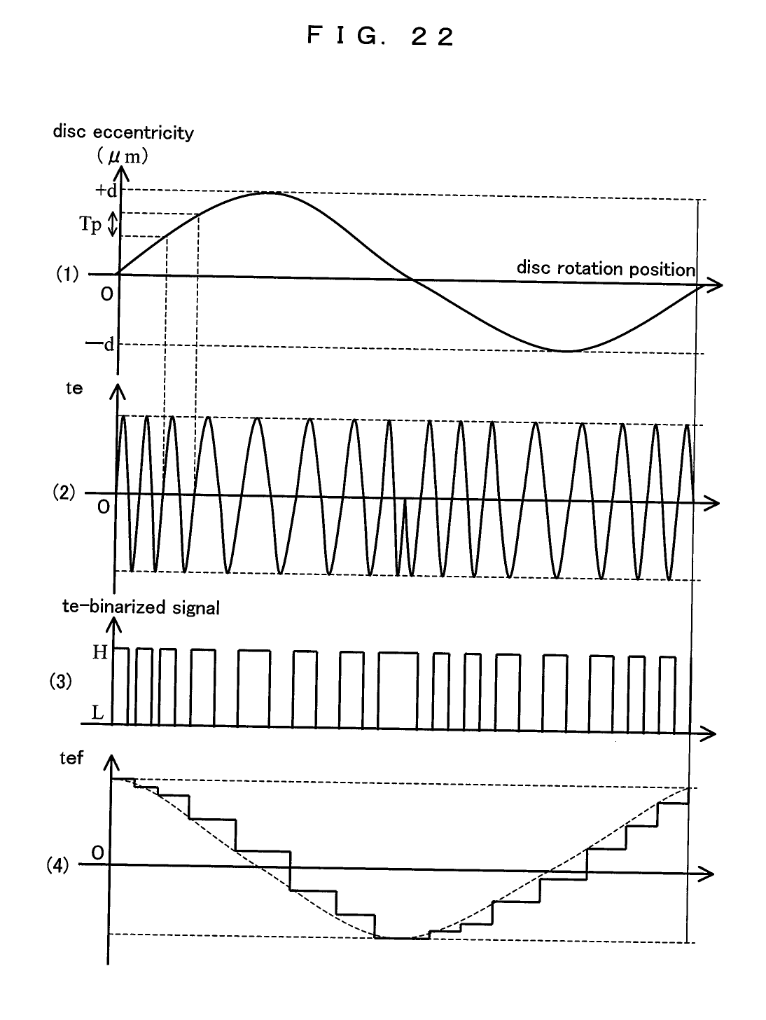

In the present invention, however, the tracking control state may not be necessary for the displacement amount d to be detected. Below are described a structure and a method in which a tracking control state is not required, referring to FIGS. 21 and 22. FIG. 21 is a block diagram of an optical disc device according to the present invention. In the description of the optical disc device given below, the same structural elements as those provided in the optical disc device illustrated in FIG. 18 will not be described again, and different structural elements will be described. The drive output tkd of the tracking controller 116 is outputted to the actuator loaded in the optical pickup 3 via a switch 121. The switch 121 is opened and closed by the displacement amount detector 117. In a state where the tracking controller 116 is operating and the switch 112 is closed, a tracking control loop is closed. The displacement amount detector 117 outputs an on/off signal for opening and closing the switch 121 to the switch 121. The displacement amount detector 117 turns off the on/off signal to thereby open the switch 21 only when the eccentricity of the optical disc 1 is measured.

The tracking error detector 13 outputs the output te to a tracking error cycle detector 122. The tracking error cycle detector 122 binarizes the output te of the tracking error detector 113, and then measures the cycle of the binarized output te (pulse signal). The tracking error cycle detector 122 outputs the output te, the cycle of which was measured, to the displacement amount detector 117.

Referring to FIG. 22, a relationship among the amount of eccentricity of the optical disc 1, output te of the tracking error detector 113 and output tef of the tracking error cycle detector 122 is described. FIG. 22 illustrates a relationship among the rotation position of the optical disc 1, displacement amount d, output te, binarized signal of the output te, and output tef. As illustrated in (1) of FIG. 22, when the optical disc 1 is rotated through 360 degrees once at a certain rate, the displacement amount d changes in a sine wave shape in accordance with the amount of eccentricity of the optical disc 1. The amplitude of the displacement amount (sine wave) is increased in the case where the amount of eccentricity of the optical disc 1 is large, while the amplitude is lessened in the case where the amount of eccentricity is small.

When the light beam condensed on the optical disc 1 traverses the track of the optical disc 1, the output te of the tracking error detector 113 illustrated in FIG. 22 (2) shows the sine wave shape. In a state where the tracking control loop is open in the optical disc device 1 illustrated in FIG. 21, the output te for one cycle (sine wave signal) is outputted when the light beam moves to a different position by a distance corresponding to one track due to the eccentricity of the optical disc 1. Therefore, the distance corresponding to one track of the optical disc 1 (referred to as Tp in FIG. 22) can be detected when the cycle of the output tel is measured.

The tracking error cycle detector 122 binarizes the output te of the tracking error detector 122. A te-binarized signal is illustrated in FIG. 22 (3). In the te-binarized signal, the output te and zero level are compared to each other. Next, a signal tef obtained when a cycle of the rising edge of the te binarized signal is detected and inversed is detected. The signal tef is shown in a solid line in FIG. 22 (4). The signal tef denotes a detected variation speed at which the radius position varies in accordance with the rotation position of the optical disc 1 when the optical disc 1 having a certain amount of eccentricity is rotated. The variation speed denotes an eccentricity speed which is a differential value of the amount of eccentricity relative to the rotation position of the optical disc 1. Thus, the eccentricity speed is detected.

The size of the signal tef is proportional to the amount of eccentricity of the optical disc 1. The size is increased as the amount of eccentricity of the optical disc 1 is larger, and reduced as the amount of eccentricity is smaller. Therefore, by detecting a maximum value or a minimum value of the signal tef during one rotation of the optical disc 1 and the disc rotation position at which such a value is detected, the displacement amount d in each of the recording layers can be detected as a speed.

The displacement amount detector 117 according to the present preferred embodiment integrates the output tef of the tracking error cycle detector 122 during one rotation of the optical disc 1, and detects the integration value measured in each of the recording layers as the amount of eccentricity. Further, the displacement amount detector detects a difference between the outputs clk of the clock generator 120 in which the maximum value of the output tef is detected as a phase displacement amount.

As described so far, according to the present preferred embodiment, the displacement amount d can be detected based on the amount of eccentricity even if the tracing loop of the optical disc device is open. As a result, the displacement amount d can be very accurately detected without any dependence on the control characteristics of the tracking controller 116.

So far were described the first and second examples of the detailed steps of calculating the displacement amount d. Next, a method of estimating from the displacement amount d a total number of sectors M in the area to be actually set as non-usable in the test recording area is described. The number of sectors M corresponds to a value obtained when “the number of sectors in the area where the test recording can be actually executed in the GAP area” is subtracted from “a total number of sectors in the GAP area”. Provided that the track radius in a periphery of the GAP area targeted for the estimation is R_{GAP}, a length of a unit to which the address value is supplied (conventionally, a unit of sector) is L, and a pitch of the track is Tp, the M, which is “the total number of sectors in the area to be actually set as non-usable in the test recording area”, can be calculated by the following formula (13).

M=2π/(L·Tp))·R_{GAP}·d (13)

(2π/(L·Tp)) is a value which can be calculated in advance. The value of R_{GAP} is calculated from an address value A_{GAP} in the periphery of the GAP area based on the formula 8) described earlier. In the following formula (8-1), the respective data described earlier are assigned to the formula (8).

R_{GAP}=SQRT(Tp·L·(A_{GAP}−A₀)/π+R₀²) (8-1)

The position of the test recording area (IDTAZ) on the inner-peripheral side is predetrmined. Therefore, the value of RA_{GAP} can be calculated in advance except for any case where the calculation has to be extremely accurate. According to the present invention, therefore, “the total number of sectors M in the area to be actually set as non-usable in the test recording area” is calculated, and the test recording areas in the respective layers (positions and recording amounts) are decided so that they are distant from each other by the number of sectors M calculated in the respective layers or more. Accordingly, the area previously defined as non-usable (GAP area or the like) can be effectively utilized, and the number of times additional writing can be performed can be increased and the recording quality can be improved. In contrast, in the conventional technology, it was necessary for the area where the test recording was already completed in one of the layers and the area where the test recording was already completed in the other layer (defined based on the number of sectors) to be distant from each other by at least the total number of sectors in the GAP area.

As described, the displacement amount d generated when the first information recording layer L0 and the second information recording layer L1 are bonded to each other so that the optical disc device 1 is manufactured is calculated based on, for example, a correlation between the address read from the first information recording layer L0 and the address read from the second information recording layer L1, and the GAP area of the optical disc 1 is calculated from the calculated displacement amount d. Then, when a recording operation is requested by the recording/reproducing device 12, and it is determined in an initial stage of the test recording that the recordable area in the ordinary test recording area has run out, the GAP area which is normally non-usable is set as a next candidate of the recordable area, and it is determined if there is any recordable area in the GAP area. When it is determined that there is a recordable area, the test recording is implemented in the GAP area.

A recordable area can be increased when the GAP area is thus effectively utilized. As a result, the number of time additional writing can be performed in the optical disc 1 can be increased.

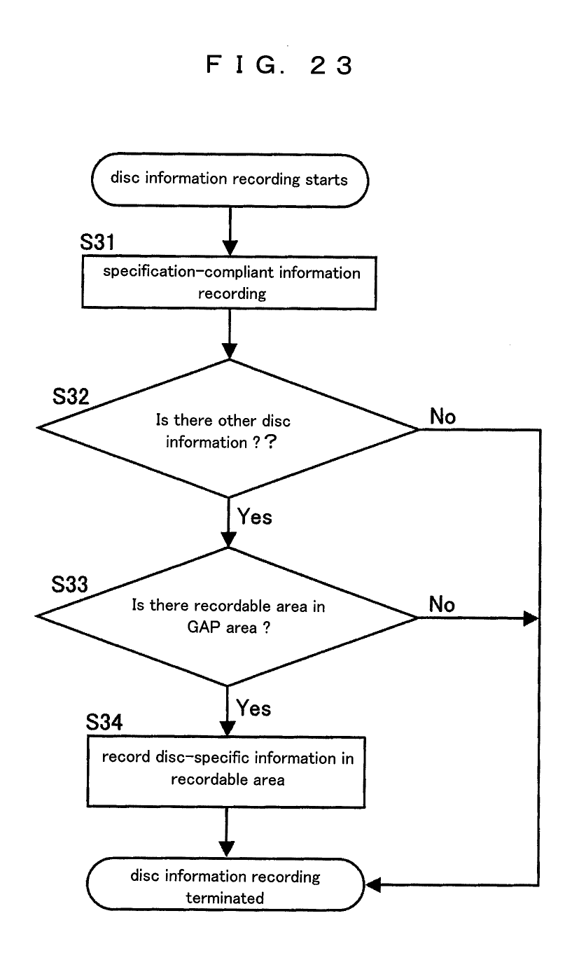

In place of the steps illustrated in the flow chart of FIG. 4, the steps illustrated in the flow chart of FIG. 23 are also effective. FIG. 23 is a flow chart illustrating a disc information recording operation by the optical disc device E.

In Step S31, specification-compliant disc information is recorded in a predetermined area of the optical disc 1. The disc information is specific control information generated by the combination of the optical disc and the optical disc device, an example of which is RMD (Recording Management Data) in the DVD-R. In Step S32, it is determined whether or not there is any disc specific information other than the specification-compliant disc information. In the case where there is no disc specific information, the operation is terminated. In the case where there is disc specific information, the operation advances to Step S33. In Step S33, it is determined whether or not there is any recordable area in the GAP area which is regarded as non-usable. The disc specific information is specific information generated depending on the combination of the optical disc and the optical disc device E, and information effective for realizing the recording and reproduction in a reliable manner. Examples of the information are a temperature corrected value of the laser power, tilt information for each radius position, conditions of information on temperature and time use for adjustment, information on a defined GAP area (thereafter, it is unnecessary to define the GAP area), eccentricity information, mass eccentricity information, inter-layer information (TR/FC Gain•Att, Tilt, . . . ), information on each layer (TR/FC Gain•Att, Tilt, . . . ) (however, these pieces of information are not defined by the specification).

In the case where a recordable area is found in the GAP area, the operation advances to Step S34, wherein the disc specific information is recorded in the area. In the case where no recordable area is found in the GAP area, the disc specific information is not recorded.

The disc specific information thus recorded is read for use when the disc is subsequently activated. By doing so, recording and reproducing operations can be performed in the optical disc 1 optimally set. As a result, the recording and reproduction can achieve a higher quality. The present invention can be applied to a multilayered recording disc other than the DVD-R Dual layer medium.

### INDUSTRIAL APPLICABILITY

An optical disc device control method according to the present invention, which effectively utilizes a non-usable area such as GAP in an optical disc having a multilayered structure where recording layers are bonded to each other, is useful for increasing the number of times additional writing can be performed, improving a recording quality, and other purposes.

What is claimed is:

1. A method for controlling an optical disc device for recording and reproducing data of an optical disc having a multilayer structure in which recording layers are bonded to each other, comprising steps of:
calculating a displacement amount generated when the recording layers are bonded to each other; and
identifying the size of a recordable area in a non-usable area predetermined on the recording layer based on the displacement amount.

2. The method for controlling an optical disc device as claimed in claim 1, further comprising a step of implementing a test recording in the recordable area whose size is identified.

3. The method for controlling an optical disc device as claimed in claim 2, wherein
the size of the recordable area used for a recording operation in each test recording operation is set based on the displacement amount in the step of implementing the test recording in the recordable area whose size is identified.

4. The method for controlling an optical disc device as claimed in claim 1, wherein
the step of calculating the displacement amount includes steps of:
reading an address of each of the recording layers at the same radius position of the optical disc; and
calculating the displacement amount generated when the recording layers are bonded to each other by comparing the read addresses.

5. The method for controlling an optical disc device as claimed in claim 1, further comprising a step of memorizing disc information including information relating to the recordable area.

6. A method for controlling an optical disc device for recording and reproducing data of an optical disc having a multilayer structure in which recording layers are bonded to each other, comprising steps of:
determining whether or not a test recording is implemented in a predetermined non-usable area depending on a displacement amount generated when the recording layers are bonded to each other; and
implementing the test recording in the non-usable area depending on a result obtained from the determining step.

7. The method for controlling an optical disc device as claimed in claim 1, further comprising steps of:
performing a search to check whether or not there is a residual test-recordable area in a test recording area provided in the optical disc when a test recording is implemented to the optical disc;
performing a search to check whether or not there is a residual recordable area in the non-usable area when it is determined that the residual test-recordable area is not present in the test recording area; and
implementing the test recording in the residual recordable area in the non-usable area when it is determined that the residual recordable area is present in the non-usable area.

8. The method for controlling an optical disc device as claimed in claim 1, further comprising steps of:
checking whether or not there is specific control information generated depending on combination of the optical disc and the optical disc device;
checking whether or not there is a residual recording area in the non-usable area when it is determined that the specific control information is present; and
recording the specific control information in the residual recording area in the non-usable area when it is determined that the residual recordable area is present in the non-usable area.

9. The method for controlling an optical disc device as claimed in claim 1, wherein
the displacement amount is calculated based on a measurement result of eccentricity between the rotation center and the respective recording layers of the optical disc.

10. The method for controlling an optical disc device as claimed in claim 1, wherein
the displacement amount is calculated in a state where the optical disc is rotated at a rotation rate lower than a rotation rate in normal recording and reproducing operations.

11. A method for controlling an optical disc device for recording and reproducing data of an optical disc having a multilayer structure in which recording layers are bonded to each other, comprising steps of:
calculating a displacement amount generated when the recording layers are bonded to each other; and
implementing a test recording in a non-usable area predetermined on the recording layer, wherein
the size of a recordable area used for a recording operation in each test recording operation is set based on the displacement amount in the step of implementing the test recording in the non-usable area.

12. An optical disc device for executing recording and reproducing operations with respect to an optical disc having a multilayered structure having recording layers bonded to each other, comprising:
a displacement amount calculator for calculating a displacement amount generated when the recording layers are bonded to each other; and
a recordable area identifier for identifying the size of a recordable area in a non-usable area predetermined on the recording layer based on the displacement amount.

13. The optical disc device as claimed in claim 12, wherein
a test recording is implemented in the recordable area whose size is identified.

14. The optical disc device as claimed in claim 13, wherein
the recorder sets the size of the recordable area used for a recording operation in each test recording operation based on the displacement amount.

15. The optical disc device as claimed in claim 12, wherein
the displacement amount calculator reads an address of each of the recording layers at the same radius position of the optical disc, and calculates the displacement amount generated when the recording layers are bonded to each other by comparing the read addresses.

16. The optical disc device as claimed in claim 12, wherein
disc information including information relating to the recordable area is memorized.

17. An optical disc device for executing recording and reproducing operations with respect to an optical disc having a multilayered structure having recording layers bonded to each other, comprising a determiner for determining whether or not a test recording is implemented in a predetermined non-usable area depending on a displacement amount generated when the recording layers are bonded to each other, wherein
the test recording is implemented in the non-usable area depending on a result of the determination by the determiner.

18. The optical disc device as claimed in claim 12, further comprising:
a first searcher for performing a search to check whether or not there is a residual test-recordable area in a test recording area provided in the optical disc when a test recording is implemented to the optical disc;
a second searcher for performing a search to check whether or not there is a residual recordable area in the non-usable area when it is determined by the first searcher that the residual test-recordable area is not present in the test recording area, wherein
the test recording is implemented in the residual recordable area in the non-usable area when the second searcher determines that the residual recordable area is present in the non-usable area.

19. The optical disc device as claimed in claim 12, further comprising:
a first confirmer for confirming whether or not there is specific control information generated by the combination of the optical disc and the optical disc device; and
a second confirmer for confirming whether or not there is a residual recordable area in the non-usable area when the first confirmer confirms that the specific control information is present, wherein
the specific control information is recorded in the residual recordable area in the non-usable area when the second confirmer confirms that the residual recordable area is present in the non-usable area.

20. The optical disc device as claimed in claim 12, wherein
the displacement amount calculator calculates the displacement amount based on a measurement result of eccentricity between the rotation center and the respective recording layers of the optical disc.

21. The optical disc device as claimed in claim 12, wherein
the displacement amount calculator calculates the displacement amount in a state where the optical disc is rotated at a rotation rate lower than a rotation rate in normal recording and reproducing operations.

22. An optical disc device for executing recording and reproducing operations with respect to an optical disc having a multilayered structure having recording layers bonded to each other, comprising a displacement amount calculator for calculating a displacement amount generated when the recording layers are bonded to each other, wherein
a test recording is implemented in a non-usable area predetermined on the recording layer by a recording amount corresponding to the displacement amount.
